(19) United States
(12) Patent Application Publication
(10) Pub. No.: US 2026/0073402 A1
(43) Pub. Date: Mar. 12, 2026

(54) SYSTEMS AND METHODS FOR PREDICTING ENVIRONMENTAL EMISSIONS BASED ON ANIMAL NUTRITION

(71) Applicant: CAN TECHNOLOGIES, INC., Wayzata, MN (US)

(72) Inventors: Ketil Christensen, Bergen (NO); Kim Hetland, Klepp Stasjon (NO); Kari Juhani Ruohonen, Turku (FI)

(73) Assignee: CAN TECHNOLOGIES, INC., Wayzata, MN (US)

(21) Appl. No.: 18/719,417

(22) PCT Filed: Dec. 15, 2022
(86) PCT No.: PCT/US2022/081643

§ 371 Date: Jun. 13, 2024

Related U.S. Application Data
(60) Provisional application No. 63/265,624, filed on Dec. 17, 2021.

(51) Int. Cl. G06Q 30/018; A01K 61/10; A23K 50/80; G06Q 50/02

(52) U.S. Cl. CPC G06Q 30/018; A23K 50/80; G06Q 50/02; A01K 61/10

(57) ABSTRACT

A system and method for determining an environmental impact from an animal production process includes determining a raw material environmental footprint profile for one or more raw materials to be used in a feed formulation for an animal product, determining an animal feed environmental footprint profile. The animal feed environmental footprint profile is determined based on the feed formulation including the one or more raw materials. The system and method further include determining an animal production and processing environmental footprint profile for producing and processing the animal product, determining an overall environmental footprint profile by combining the raw material environmental footprint profile, the animal feed environmental footprint profile, and the animal production and processing environmental footprint profile, and adjusting the feed formulation based on the overall environmental footprint profile to achieve a target emission value.

### CROSS-REFERENCE TO RELATED APPLICATIONS

This application claims the benefit of U.S. Provisional Patent Application No. 63/265,624, filed Dec. 17, 2021, which is hereby incorporated by reference in its entirety.

### BACKGROUND

Animal production, whether involving land-based animals (e.g., cattle, swine, sheep, or poultry) or aquatic animals (e.g., fish, shrimp, crocodilians, etc.) may have various environmental impacts. These environmental impacts may include environmental emissions, land use, natural resource depletion, water use, biodiversity impacts, etc. Tracking and regulating the environmental impacts of an animal production process, including environmental emissions, may be desired for a variety of reasons including enforcing governmental regulations and addressing climate change and/or other environmental issues.

### SUMMARY OF THE INVENTION

The systems, methods, and devices of this disclosure each have several innovative aspects, no single one of which is solely responsible for all of the desirable attributes disclosed herein.

Various aspects of the disclosure may now be described with regard to certain examples and aspects, which are intended to illustrate but not limit the disclosure. Although the examples and aspects described herein may focus on, for the purpose of illustration, specific systems and processes, one of skill in the art may appreciate the examples are illustrative only and are not intended to be limiting.

In accordance with some aspects of the present disclosure, a method is disclosed. The method includes determining, by a processor executing computer-readable instructions stored on a memory, a raw material environmental footprint profile for one or more raw materials to be used in a feed formulation for an animal product, determining, by the processor, an animal feed environmental footprint profile, wherein the animal feed environmental footprint profile is determined based on the feed formulation comprising the one or more raw materials, determining, by the processor, an animal production and processing environmental footprint profile for producing and processing the animal product, determining, by the processor, an overall environmental footprint profile by combining the raw material environmental footprint profile, the animal feed environmental footprint profile, and the animal production and processing environmental footprint profile, and adjusting, by the processor, the feed formulation based on the overall environmental footprint profile to achieve a target emission value.

In accordance with some aspects of the present disclosure, non-transitory computer-readable medium having computer-executable instructions stored thereon is disclosed. The computer-executable instructions when executed by at least one processor cause the at least one processor to determine a raw material environmental footprint profile for one or more raw materials to be used in a feed formulation for an animal product, determine an animal feed environmental footprint profile, wherein the animal feed environmental footprint profile is determined based on the feed formulation comprising the one or more raw materials, determine an animal production and processing environmental footprint profile for producing and processing the animal product, determine an overall environmental footprint profile by combining the raw material environmental footprint profile, the animal feed environmental footprint profile, and the animal production and processing environmental footprint profile, and adjust the feed formulation based on the overall environmental footprint profile to achieve a target emission value.

In accordance with further aspects of the present disclosure, a system is disclosed. The system includes a memory having computer-executable instructions stored thereon and a processor that executes the computer-executable instructions to determine a raw material environmental footprint profile for one or more raw materials to be used in a feed formulation for an animal product, determine an animal feed environmental footprint profile, wherein the animal feed environmental footprint profile is determined based on the feed formulation comprising the one or more raw materials, determine an animal production and processing environmental footprint profile for producing and processing the animal product, determine an overall environmental footprint profile by combining the raw material environmental footprint profile, the animal feed environmental footprint profile, and the animal production and processing environmental footprint profile, and adjust the feed formula

The foregoing summary is illustrative only and is not intended to be in any way limiting. In addition to the illustrative aspects, aspects, and features described above, further aspects, aspects, and features may become apparent by reference to the following drawings and the detailed description.

### BRIEF DESCRIPTION OF THE DRAWINGS

FIG. 1 illustrates an example block diagram of a computing system, in accordance with some aspects of the present disclosure.

FIG. 2 illustrates an example block diagram of an environmental emission prediction system implemented by the computing system of FIG. 1, in accordance with some aspects of the present disclosure.

FIG. 3 illustrates an example flowchart outlining operations of a process for computing an overall environmental footprint profile of the environmental emission prediction system of FIG. 2, in accordance with some aspects of the present disclosure.

FIG. 4 illustrates an example flowchart outlining operations of a process for determining a raw materials environmental footprint profile used to determine the overall environmental footprint profile of FIG. 3, in accordance with some aspects of the present disclosure.

FIG. 5 illustrates an example flowchart outlining operations of a process for determining an animal feed environmental footprint profile used to determine the overall environmental footprint profile of FIG. 3, in accordance with some aspects of the present disclosure.

FIG. 6 illustrates an example flowchart outlining operations of a process for determining an animal farming environmental footprint profile used to determine the overall environmental footprint profile of FIG. 3, in accordance with some aspects of the present disclosure.

FIG. 7 illustrates an example flowchart outlining operations of a process for adjusting an animal feed formulation based on the overall environmental footprint profile of FIG. 3, in accordance with some aspects of the present disclosure.

FIG. 8 illustrates example graphs providing examples of the animal feed environmental footprint profile, animal farming environmental footprint profile, and the overall environmental footprint profile, in accordance with some aspects of the present disclosure.

### DETAILED DESCRIPTION

In the following detailed description, reference is made to the accompanying drawings, which form a part hereof. In the drawings, similar symbols typically identify similar components, unless context dictates otherwise. The illustrative aspects described in the detailed description, drawings, and claims are not meant to be limiting. Other aspects may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Animal production (e.g., animal farming, animal husbandry, etc.) may be considered an agricultural process of raising and processing animals for food and/or other products. Animal production may involve land-based animals (e.g., cattle, swine, sheep, or poultry) or aquatic animals (e.g., salmon, shrimp, etc.). The animal production process may involve many steps including but not limited to site selection, species selection, egg production and/or reproduction, animal feeding, animal harvesting, transportation, etc. Animal production may generally include raising/producing the animals and subsequent processing of the animals to generate food products, producing the raw materials for feeding the animals, and producing animal feed from the raw materials for feeding the animals. In other cases, animal production may include other or additional processes. Animal production may have a variety of environmental impacts. For example, natural resources such as fossil fuels may be used to transport items (e.g., animal feed, animals, equipment, etc.), producing environmental emissions. Generating raw materials, raising/producing animals, etc. may all have various environmental impacts. Some agricultural stake holders (e.g., animal farmers, animal producers, regulatory environmental agencies) may be interested in evaluating the overall environmental footprint of an animal production process in order to decrease the environmental impact or footprint of the animal production process. Based on the overall environmental footprint, the stake holders may modify one or more aspects of the animal production process to decrease the overall environmental footprint of the animal production process.

The present disclosure provides technical solutions for accurately predicting the overall environmental footprint for an animal production process and modifying one or more aspects of the animal production process based on the predicted overall environmental footprint to reduce the environmental impact of an animal production process (e.g., reduce emissions, reduce natural resource use, etc.). For example, an environmental footprint prediction application may receive a variety of inputs (e.g., emissions related to raw materials, energy, chemicals, facilities, etc., used during a salmon production process) and compute an overall environmental footprint. Based on the overall environmental footprint, one or more aspects of the animal production process may be varied. For example, in some aspects, the feed formulation used for feeding the animals may be varied to reduce environmental impact.

Thus, the present disclosure provides/considers a holistic view of the environmental impact of the animal production process. The present disclosure provides a mechanism to accurately predict the environmental impact from various stages of animal production. Specifically, the present disclosure considers the environmental impact of various stages/processes of animal production, including the raw material production and animal farming/processing. The present disclosure also provides a mechanism to fine tune and/or change various aspects of the animal production process to achieve a desired environmental impact. By modifying the feed formulation, the present disclosure may allow for varying the raw materials that may be used in formulating the feed, thereby changing the environmental impact associated with a particular raw material. For example, in some aspects, the feed formulation may replace one raw material with another raw material that provides similar nutritional value but at a lower environmental impact (e.g., due to requiring less resources to grow, process, transport, etc.).

The disclosure below is described with respect to salmon production. Using salmon production is simply for the sake of clarity and simplicity, but aspects are not limited thereto. The present disclosure may be equally applicable to any type of animal production including but not limited to hog production, beef production, poultry production, other types of animal production, plant based food production, and the like. The present disclosure may even be applicable in other applications where accurate predictions of environmental impact are desired.

The disclosure below is described with respect to three areas of focus for predicting an overall environmental footprint profile during an animal production process: raw materials used to create an animal feed, an animal feed formulation process, and animal production and processing, but the aspects are not limited thereto. The present disclosure may be equally applicable to other areas of focus including any other environmental footprint profiles related to animal production. Though the overall environmental footprint profile is created to be a combination of the raw material environmental footprint profile, the animal feed environmental footprint profile, and the animal production and processing environmental footprint profile, in some aspects, the overall environmental footprint profile may only include a certain subset of those environmental footprint profiles or additional environmental footprint profiles not described herein.

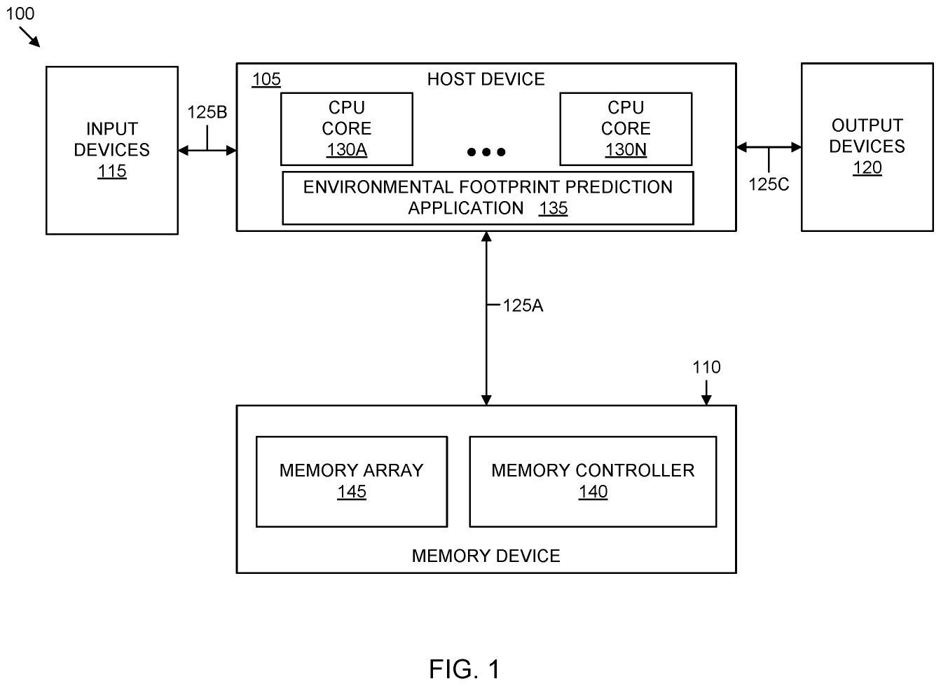

FIG. 1 illustrates an example block diagram of a computing system 100, in accordance with aspects of the present disclosure. The computing system 100 may be used for predicting an environmental footprint of an animal production process. The computing system 100 includes a host device 105 associated with a memory device 110. The host device 105 may be configured to receive input from one or more input devices 115 and provide output to one or more output devices 120. The host device 105 may be configured to communicate with the memory device 110, the input devices 115, and the output devices 120 via appropriate interfaces 125A, 125B, and 125C, respectively. The computing system 100 may be implemented in a variety of computing devices such as computers (e.g., desktop, laptop, servers, data centers, etc.), tablets, personal digital assistants, mobile devices, other handheld or portable devices, or any other computing unit suitable for performing standard cell layout using the host device 105.

The input devices 115 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 105 and that allows an external source, such as a user (e.g., a soybean processing facility manager), to enter information (e.g., data) into the host device and send instructions to the host device. Similarly, the output devices 120 may include a variety of output technologies such as external memories, printers, speakers, displays, microphones, light emitting diodes, headphones, video devices, and any other output peripherals that are configured to receive information (e.g., data) from the host device 105. The “data” that is either input into the host device 105 and/or output from the host device may include any of a variety of textual data, signal data, prediction model data, volume data, quality data, graphical data, combinations thereof, or other types of analog and/or digital data that is suitable for processing using the computing system 100.

The host device 105 includes or is associated with one or more processing units/processors, such as Central Processing Unit (“CPU”) cores 130A-130N. The CPU cores 130A-130N may be implemented as an Application Specific Integrated Circuit (“ASIC”), Field Programmable Gate Array (“FPGA”), or any other type of processing unit. Each of the CPU cores 130A-130N may be configured to execute instructions for running one or more applications of the host device 105. In some aspects, the instructions and data needed to run the one or more applications may be stored within the memory device 110. The host device 105 may also be configured to store the results of running the one or more applications within the memory device 110. Thus, the host device 105 may be configured to request the memory device 110 to perform a variety of operations. For example, the host device 105 may request the memory device 110 to read data, write data, update or delete data, and/or perform management or other operations.

One such application that the host device 105 may be configured to run may be an environmental footprint prediction application 135. The environmental footprint prediction application 135 may be part of a computer aided design or electronic design automation software suite that may be used by a user of the host device 105 to monitor and optimize the full process of collecting and processing information about the environmental impact of the animal production process. Specifically, the environmental footprint prediction application 135 may be configured to receive a variety of inputs related to an animal production process and create an overall environmental footprint profile based on the inputs. Further, the environmental footprint prediction application 135 may provide recommendations of modifications to the animal production process that may decrease the overall environmental footprint of the animal production process. For example, in some salmon production processes, cleaner fish that eat parasites within the salmon population may be used as a method of parasite control. There are a variety of different species of cleaner fish, each associated with a different environmental footprint, which may be used during the salmon production process instead to potentially reduce environmental emissions. A salmon farmer may set a certain overall environmental footprint threshold for their salmon production process. The environmental footprint prediction application 135 may predict an overall environmental footprint profile based on the type of cleaner fish used that is higher than the threshold set by the salmon farmer. In this case, the environmental footprint prediction application 135 may suggest that another cleaner fish species with a lower environmental footprint be used during salmon production process. In some aspects, the instructions needed to execute or run environmental footprint prediction application 135 may be stored within the memory device 110. The environmental footprint prediction application 135 may be executed by one or more of the CPU cores 130A-130N using the instructions associated with the mix and blend application from the memory device 110.

Referring still to FIG. 1, the memory device 110 includes a memory controller 140 that is configured to read data from or write data to a memory array 145. In some aspects, the memory array 145 may include types of volatile and/or non-volatile memories. For example, in some aspects, the memory array 145 may also include NAND flash memory cores, NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory array. Generally speaking, the memory array 145 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

The memories within the memory array 145 may be individually and independently controlled by the memory controller 140. In other words, the memory controller 140 may be configured to communicate with each memory within the memory array 145 individually and independently. By communicating with the memory array 145, the memory controller 140 may be configured to read data from or write data to the memory array in response to instructions received from the host device 105. Although shown as being part of the memory device 110, in some aspects, the memory controller 140 may be part of the host device 105 or part of another component of the computing system 100 and associated with the memory device. The memory controller 140 may be implemented as a logic circuit in either software, hardware, firmware, or combination thereof to perform the functions described herein. For example, in some aspects, the memory controller 140 may be configured to retrieve the instructions associated with the environmental footprint prediction application 135 stored in the memory array 145 of the memory device 110 upon receiving a request from the host device 105.

It is to be understood that only some components of the computing system 100 are shown and described in FIG. 1. However, the computing system 100 may include other components such as various batteries and power sources, networking interfaces, routers, switches, external memory systems, controllers, etc. Generally speaking, the computing system 100 may include any of a variety of hardware, software, and/or firmware components that are needed or considered desirable in performing the functions described herein. Similarly, the host device 105, the input devices 115, the output devices 120, and the memory device 110 including the memory controller 140 and the memory array 145 may include other hardware, software, and/or firmware components that are considered necessary or desirable in performing the functions described herein.

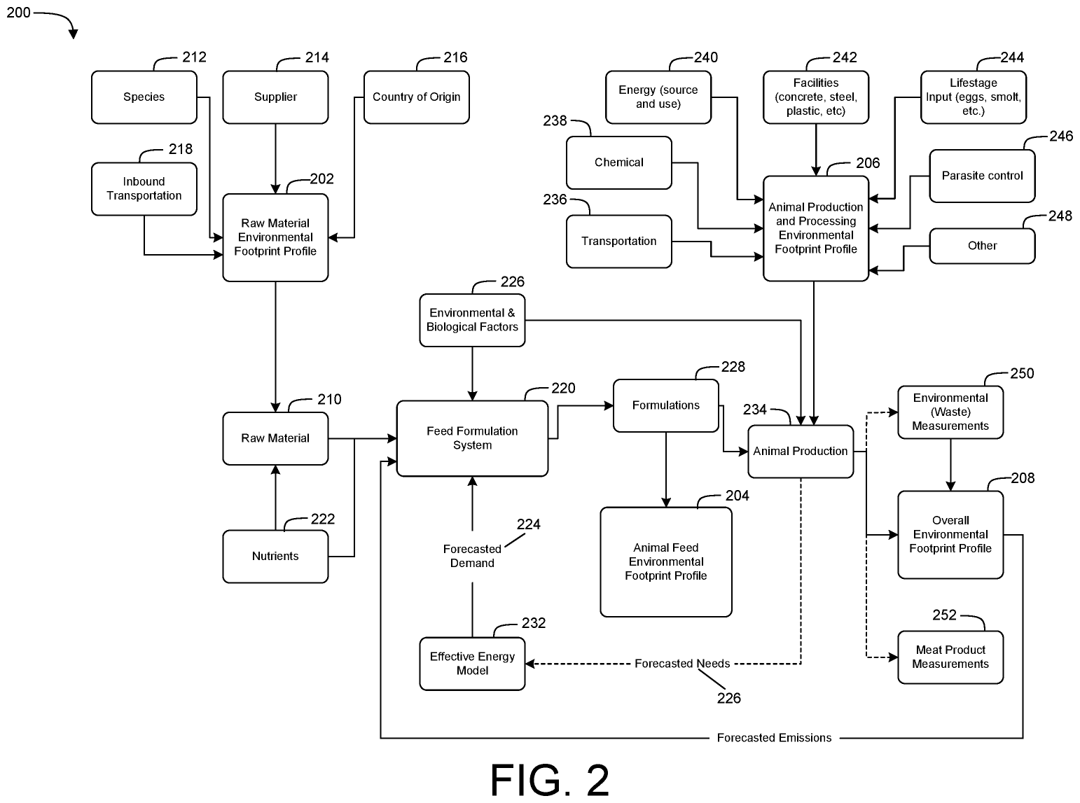

FIG. 2 illustrates an example block diagram of an environmental footprint prediction system 200 implemented by the environmental footprint prediction application 135 of the computing system of FIG. 1, in accordance with some aspects of the present disclosure. More specifically, the environmental footprint prediction system 200 may be used to create one or more environmental profiles such as a raw material environmental footprint profile 202, an animal feed environmental footprint profile 204, and/or an animal production and processing environmental footprint profile 206. One or more of the raw material environmental footprint profile 202, the animal feed environmental footprint profile 204, or the animal production and processing environmental footprint profile 206 may be combined to produce an overall environmental footprint profile 208.

Each of the raw material environmental footprint profile 202, the animal feed environmental footprint profile 204, the animal production and processing environmental footprint profile 206, and the overall environmental footprint profile 208 may be a summary of the environmental impacts that a process, such as an animal production process, may have. In some aspect, a specific environmental footprint profile may be created for each step in the animal production process. For example, the animal feed environmental footprint profile 204 may be created for the feed formulation used in the animal production process. The raw material environmental footprint profile 202 may be created for the raw materials used to create the animal feed. The animal production and processing environmental footprint profile 206 may be created for the animal growing, harvesting, and processing portion of the animal production process.

In some aspects, each of the raw material environmental footprint profile 202, the animal feed environmental footprint profile 204, the animal production and processing environmental footprint profile 206, and the overall environmental footprint profile 208 may be created by the environmental footprint prediction application 135. More specifically, a user may enter one or more inputs through the input devices 115. Each of the raw material environmental footprint profile 202, the animal feed environmental footprint profile 204, the animal production and processing environmental footprint profile 206, and the overall environmental footprint profile 208, each of which is described in more detail below, may include one or more environmental indicators as outlined in Table 1 below. In some aspects, the environmental indicators described in Table 1 may be part of the “ReCiPe2016” methodology for creating a life cycle assessment for a certain process. In other aspects, other methodologies may be used to obtain one or more of the environmental indicators.

TABLE 1
Environmental Indicators

| Environmental Indicators | Unit |
|---|---|
| Global warming - including LUC | kg CO2 eq |
| Global warming - excluding LUC | kg CO2 eq |
| Land Use Change (LUC) | kg CO2 eq |
| Land use | m2a crop eq |
| Water consumption | m3 |
| Stratospheric ozone depletion | kg CFC11 eq |
| Ionizing radiation | kBq Co-60 eq |
| Ozone formation, Human health | kg NOx eq |
| Fine particulate matter formation | kg PM2.5 eq |
| Ozone formation, Terrestrial ecosystems | kg NOx eq |
| Terrestrial acidification | kg SO2 eq |
| Freshwater eutrophication | kg P eq |
| Marine eutrophication | kg N eq |
| Terrestrial ecotoxicity | kg 1,4-DCB |
| Freshwater ecotoxicity | kg 1,4-DCB |
| Marine ecotoxicity | kg 1,4-DCB |
| Human carcinogenic toxicity | kg 1,4-DCB |
| Human non-carcinogenic toxicity | kg 1,4-DCB |
| Mineral resource scarcity | kg Cu eq |
| Fossil resource scarcity | kg oil eq |

Environmental indicators may be statistics and/or measurements that may be used to define an environmental condition of an activity or process. Example environmental indicators and the units in which those environmental indicators may be measured are shown in Table 1 above. In some aspects, the environmental indicators may include a global warming indicator. The global warming indicator may measure the amount of greenhouse gas emissions produced per amount of feed in units of kg CO₂ eq. In some aspects, the environmental indicators may include a land use change indicator. Land use change may refer to when a natural landscape is transformed by humans in order facilitate an activity or process. For example, clearing a forest to create room for growing a raw material, building a feed mill, or building a salmon production facility may be considered a land use change. Land use change may cause an increase in greenhouse gas emissions in two ways. First, a variety of natural landscapes (e.g., forests and oceans) provide carbon sinks that absorb greenhouse gas emissions (e.g., CO₂) from the atmosphere. When these natural landscapes are transformed through land use changes such as deforestation, they may no longer function as carbon sinks thereby increasing the amount of greenhouse gases in the atmosphere. Second, the process of transforming the natural landscape often requires the use of fossil fuels and other natural resources leading to the secondary source of emissions related to land use change. The land use change indicator may measure the emissions related to the land use change in units of kg CO₂ eq.

In some aspects, the environmental indicators may include a land use indicator. The land use indicator may measure the amount of land used during feed formulation process in units of m²a crop eq. In some aspects, the environmental indicators may include a water consumption indicator. A certain amount of water consumption may be used during the animal production process for a variety of reasons. For example, while creating an animal feed, a certain amount of water may be during the processing and formulation of the animal feed. The water consumption indicator may be measured in units of volume (e.g., m³, liters, gallon, etc.).

In some aspects, the environmental indicators may include one or more stratosphere condition indicators. The stratosphere refers to the second layer of the atmosphere where the ozone layer is located. The ozone layer absorbs harmful ultraviolet radiation from the sun. When ozone molecules within the ozone layer come in contact with ozone depleting substances (e.g., chlorofluorocarbons, halons, carbon tetrachloride, methyl chloroform, hydrobromofluorocarbons, hydrochlorofluorocarbons, methyl bromide, bromochloromethane), the ozone molecules may be destroyed leading to a depleted ozone layer. Ozone depleting substances may be produced during various steps of the animal production process including. One of the stratosphere condition indicators may be a stratospheric ozone depletion indicator that measures the amount ozone depleting substances produced during a feed formulation process including but not limited to chloroflourocarbons, halons, carbon tetrachloride, methyl chloroform, hydrobromofluorocarbons, hydrochlorofluorocarbons, methyl bromide, and bromochloromethane. The ozone depleting substances may be expressed in units of kg CFC11 eq. One of the stratosphere condition indicators may be an ionizing radiation indicator that measures the amount of ionizing radiation produced during the animal process in units of kBq Co-60 eq. Ionizing radiation may be produced during the animal production process whenever anything is transported (e.g., transporting a raw material to a feedmill, transporting the feed from the feed mill to an salmon production facility, transportation from the salmon production facility to a salmon processing facility, etc.). One of the stratosphere condition indicators may be an ozone pollution indicator that measures the amount of ozone pollution produced during the feed formulation process the feed formulation process in units of kg NOx eq. Ozone pollution may also be produced as a byproduct of transportation within the animal production process. Ozone pollution can have a variety of negative effects including but not limited to damaging the human respiratory system, loss of species diversity, loss of habitat quality, change of water and nutrient cycles in ecosystems, and a reduction in photosynthesis within plants. One of the stratosphere condition indicators may be a fine particulate matter formation indicator that measures the amount of fine particulate matter created during the animal production process in units of kg PM_{2.5} eq. Fine particulate matter refers to tiny particles or droplets within air pollution that are two and one half microns or less in width.

In some aspects, the environmental indicators may include one or more acidification and eutrophication indicators. Acidification refers to a process wherein the pH of a piece of land or body of water decreases over time. For example, in terrestrial acidification, the pH of the soil decreased over a period of time. Acidification may be caused by chemicals used/produced during the animal production process. Additionally, acidification may be caused by environmental emissions, more namely carbon emissions. Therefore, one of the acidification and eutrophication indicators may be a terrestrial acidification indicator that measures the acidification potential of the feed formulation process in units of kg SO₂ eq. Eutrophication refers to a process by which a body of water, or at least some part of the body of water becomes progressively enriched with minerals and nutrients leading to an increased growth of plant life and death of animal life because of a lack of oxygen due to the increased plant life. Therefore, one of the acidification and eutrophication indicators may be a freshwater eutrophication indicator that measures the eutrophication potential within the animal production process within freshwater (e.g., rivers, lakes, etc.) in units of kg P eq. Another acidification and eutrophication indicator may be a marine eutrophication indicator that measures the eutrophication potential of a feed formulation process within marine waters (e.g., oceans, seas, etc.) in units of kg N eq.

In some aspects, the environmental indicators may include one or more toxicity indicators. For example, one of the toxicity indicators may be a terrestrial ecotoxicity indicator. Terrestrial ecotoxicity refers to chemical substances produced during an activity or process that may be toxic to terrestrial plants and organisms. The terrestrial ecotoxicity indicator may measure the toxicity potential of the chemical substances produced during the feed formulation process in units of kg 1,4-DCB. Another toxicity indicator may be a freshwater ecotoxicity indicator. Freshwater toxicity refers to chemical substances produced during an activity or process that may be toxic to terrestrial plants and organisms. The freshwater ecotoxicity indicator may measure the toxicity potential of the chemical substances produced during the animal production process in units of kg 1,4-DCB. Another toxicity indicator may be a marine ecotoxicity indicator. Marine toxicity refers to chemical substances produced during an activity or process that may be toxic to marine plants and organisms. The marine ecotoxicity indicator may measure the toxicity potential of the chemical substances produced during the animal production process in units of kg 1,4-DCB. Another toxicity indicator may be a human carcinogenic toxicity indicator. Human carcinogenic toxicity refers to toxic chemical substances that may be carcinogenic (e.g., cause cancer). The human carcinogenic toxicity indicator may measure the toxicity potential of the chemical substances produced during the feed formulation process in units of kg 1,4-DCB. A final toxicity indicator may be a human non-carcinogenic toxicity indicator. Human non-carcinogenic toxicity refers to toxic chemical substances that may be toxic for human life but not necessarily carcinogenic.

In some aspects, the environmental indicators may include one or more natural resource scarcity indicators. A variety of natural resources are used in the feed formulation process including minerals and fossil fuels. For example, a feed formulation may include one or more minerals (e.g., phosphate limestone, calcium, sodium, etc.). Fossil fuels may also be used to create and transport the animal feed. Each of these natural resources do not exist in unlimited abundance, therefore their scarcity must be considered when creating an environmental footprint profile. More specifically, one of the natural resource scarcity indicators may be a mineral resource scarcity indicator that measures the surplus ore potential in units of kg Cu eq. The surplus ore potential is defined as the extra amount of ore produced in the future per unit of mineral extracted. Another natural resource scarcity indicator may be a fossil fuel resource scarcity indicator that measures the future scarcity potential of one or more fossil fuels in units of kg oil eq. The environmental indicators described above in Table 1 are only an example. In other aspects, other or additional environmental indicators may be used.

The raw material environmental footprint profile 202 describes the environmental footprint of a raw material 210 that may be used as an ingredient within an animal feed. In some aspects, an animal feed may be composed of a variety of raw materials. For example, an animal feed used during salmon production may include corn, fish, vitamins, and minerals which may be directly raw materials or derived from raw materials. Raw material production may include growing, harvesting, and processing plants and/or animals, mining minerals and/or other natural resources, and transporting each raw material to facility in which they may be combined to create an animal feed. The raw material 210 may be defined as the organic matter that may be used as ingredient within an animal feed. For example, a raw material may include plants and plant derivatives (e.g., com, soybeans, plant based oils, etc.). As another example, raw materials may include animals and animal derivatives (e.g., fishmeal, fish oil, etc.). As another example, the raw material may be minerals and/or other chemical compounds (e.g., limestone, salt, phosphate, etc.). A feed formulation process may combine one or more raw materials in a variety of configurations in order to create an animal feed as described in more detail below.

Multiple inputs may be entered into the environmental footprint prediction application 135 in order to create the raw material environmental footprint profile 202. In some aspects, a species input 212 may be used to create the raw material environmental footprint profile 202. More specifically, the species of all the plants and animals that make up the raw material 210 of a feed formulation may be included. For example, if the raw material 210 includes a fishmeal, the species of the particular fish that the fishmeal is made of may be entered. In some aspects, the species input 212 may be used to determine an emission level associated with producing that particular species of plant or animal. For example, producing a certain species of fish may have a certain emission level and producing a certain species of soybean may be associated with a different emission level. If each of the particular fish species and soybean species is included in an animal feed, then their respective emission levels may be included in the raw material environmental footprint profile 202.

For example, in some aspects, environmental impact values (e.g., values for the environmental indicators) for each species of raw material may be provided by the supplier of the raw material through a supplier input 214. In other aspects, the supplier may supply other information that allows a user to create environmental impact values for the product supplied by the supplier. For example, the supplier may provide what type of product is produced, where the product was produced, all the entities involved in producing the product, etc., and based on that information, the environmental impact values may be determined. In some aspects, the environmental footprint for each species of raw material may be received from one or more environmental information databases. The one or more environmental information databases may include environmental information about a species of raw material (e.g., emissions produced, land use, water use, toxicity levels, fossil fuel use, natural resource use, etc.) In some aspects, the environmental information obtained from the one or more environmental information databases may be used to determine one or more environmental indicators (as described in Table 1 above) which may then be combined to create the raw material environmental footprint profile 202. In some aspects, a look up function may be performed to obtain the environmental information for a particular species of raw material. In some aspects, the one or more environmental information databases may be updated periodically (e.g., annually, semi-annually, etc.) to more accurately reflect current environmental information. In some aspects, the one or more environmental information databases may comprise historical environmental data. The one or more environmental information databases may receive environmental information from a variety of sources including environmental agencies and organizations, universities, businesses, corporations, etc. In other aspects, environmental information may be received from a different source separate from the one or more environmental information databases. In some aspects, the databases may be stored in the memory device 110. Alternately, the databases may be stored externally out of the computing system 100 and are accessible to the environmental footprint prediction application 135 through a network connection (e.g., Wi-Fi, Ethernet, Bluetooth, etc.). These particular environmental footprints of each of these species may be used when creating the raw material environmental footprint profile 202.

In some aspects, a country of origin input 216 may be used to create the raw material environmental footprint profile 202. The country of origin may refer to the country in which a raw material (e.g., ingredient of a raw material) is produced. In some aspects, the country of origin input may be received directly from a supplier of a raw material and may be input through the supplier input 214. In other aspects, the country of origin input may not be supplied directly from the supplier and may be determined through other means. In this case, the country of origin may be entered through the country of origin input. Countries may keep one or more environmental information databases that store information including but not limited to greenhouse gas emissions, electricity use, land use, and natural resource use associated with producing various raw materials in their country. One or more databases may be created that associate the emission with each country from which a raw material is sourced. In some aspects, the databases may be stored in the memory device 110. Alternately, the databases may be stored externally out of the computing system 100 and are accessible to the environmental footprint prediction application 135 through a network connection (e.g., Wi-Fi, Ethernet, Bluetooth, etc.). The environmental footprint prediction application 135 may refer to these databases to create the raw material environmental footprint profile 202.

In some aspects, an inbound transportation input 218 may be used to create the raw material environmental footprint profile 202. An inbound transport may refer to the transportation of the raw material from where the raw material is produced (e.g., a farm) to a feed mill or other facility where the raw material may be further processed to create the animal feed. Through the input devices 115, transportation information associated with fuel used and greenhouse gas emissions produced during inbound transportation may be tracked and entered into the environmental footprint prediction application 135 as an inbound transportation input 218. In some aspects, this transportation information may include mode of transportation, the fuel source used, the distance traveled, the duration of travel, etc. In some aspects, the environmental footprints associated with the inbound transport may be received directly from an entity facilitating the inbound transportation (e.g., vehicle operators and/or managers). For example, a truck driver transporting raw materials from a raw material producer to a feed mill may track the distance traveled, the amount of fuel used, and the amount of emissions produced during the trip. The driver may then enter each of these values into a computing device (e.g., computing system 100) which may then use these values to calculate an emission associated with an inbound transport. In other aspects, the emission associated with the inbound transport may be received from a transportation database that stores environmental information (e.g., emissions produced, land use, water use, toxicity levels, fossil fuel use, natural resource use, etc.) related to transportation. More specifically, the transportation information received may be compared to one or more databases to determine one or more environmental indicators (as described in Table 1 above) associated with an inbound transport. In some aspects, a look up function may be performed to obtain the environmental information for the transportation of a raw material. In some aspects, the transportation databases may be updated periodically (e.g., annually, semi-annually, etc.) to more accurately reflect current environmental transportation information. The one or more transportation databases may receive environmental information from a variety of sources including environmental agencies and organizations, universities, businesses, corporations, etc. In other aspects, environmental information may be received from a different source separate from the one or more environmental information databases. In some aspects, the transportation databases may be stored in the memory device 110. In some aspects, an outbound transportation input may additionally be used. An outbound transportation input may refer to the transportation of the raw material for further processing from the processing facility (e.g., feed mill) to another facility for additional processing.

Upon the environmental footprint prediction application 135 receiving one or more of the species input 212, the supplier input 214, the country of origin input 216, and the inbound transportation input 218, the environmental footprint prediction application 135 may create the raw material environmental footprint profile 202. In some aspects, the raw material environmental footprint profile 202 may add all the emissions received through the species input 212, the supplier input 214, the country of origin input 216, and the inbound transportation input 218 as described above to create the raw material environmental footprint profile 202. For example, a land use change indicator may be determined from the species input 212, another land use change indicator may be determined from the supplier input 214, and another land use change indicator may be determined from the inbound transportation input 218. In this case, the land use change indicators may be added together to create an overall land use change indicator used as one of the indicators that make up the raw material environmental footprint profile 202. Thus, the raw material environmental footprint profile 202 may include one or more of the environmental indicators as summarized in Table 1 above. Though the species input 212, the supplier input 214, the country of origin input 216, and the inbound transportation input 218 are described as the inputs used to create the raw material environmental footprint profile 202, other and/or additional inputs may also be used in the creation of the raw material environmental footprint profile 202.

In some aspects, a life cycle analysis (LCA) may be used to create the raw material environmental footprint profile 202. The LCA may be a methodology of studying the environmental impact of an entire animal production process from start to finish. In some aspects, LCA may include four main phases:
1) Defining the goal and scope of the study (e.g., environmental impact from raw materials).
2) Making a model of the product life cycle with all the environmental inputs and outputs. This data collection effort may be referred to as the life cycle inventory (LCI) (e.g., collecting the species input 212, the supplier input 214, the country of origin input 216, and the inbound transportation input 218).
3) Understanding the environmental relevance of all the inputs and outputs. This is referred to as life cycle impact assessment (LCIA) (creating the raw material environmental footprint profile 202).
4) The interpretation of the study (e.g., analyze the results and modify one or more aspects to achieve a desired result).

In some aspects, the environmental footprint prediction system 200 may create multiple raw material environmental footprint profiles. For example, if an animal feed contains more than one raw material, a separate raw material environmental footprint profile may be created for each raw material in the feed formulation.

The raw material 210 may be used to create animal feed through a feed formulation system 220. The feed formulation system 220 may be configured to develop a feed formulation 228. The feed formulation system 220 identifies or obtains data associated with the raw material 210, and one or more constituent nutrients 222 provided by the raw material 210 and combinations of the raw material. Such nutrients may include compositions of amino acids, lipids, glucose, vitamins, and minerals, provided by the nutrients and combinations of nutrients. In some aspects, the feed formulation system 220 may evaluate the nutrients 222 in the context of relationships within digestible energy as indicated in an effective energy model 232. In other aspects, other or additional nutrients and relationships may be evaluated. In some aspects, the feed formulation 228 describes what raw materials may be included within an animal feed and what percentage of the animal feed is made up by each raw material. For example, a feed formulation 228 may be described as 60% corn, 20% soybean meal, 10% fishmeal, and 10% soy bean oil.

The feed formulation system 220 identifies or obtains data for a forecasted demand 224 for growth and energy needs of the animal production 234. This may include a consideration of “essential” energy based on the digestible energy relationships among non-effective energy (non-nitrogenous digestible energy), effective energy (nitrogenous digestible energy), and microingredients. To identify the forecasted demand 224, a set of forecasted needs for the particular animal population may be considered by the feed formulation system 220.

To identify the forecasted needs, the feed formulation system 220 may also identify or obtain data relating to environmental and biological factors 226, which affect the growth cycle, usage, and demand of energy. For instance, in the production of aquaculture such as salmon, seasonality provides direct changes in sunlight, water temperature that has an impact on how much energy is needed for basic metabolism and physiological activities. Also, for instance, in the production of salmon, a genetic makeup (e.g., associated with the salmon breed or type) may have an effect on the overall size and rate at which individual fish may grow.

The feed formulation system 220 may develop the feed formulation 228 in the context of tissue growth for muscle and fat tissue of meat products. Such tissue growth may be correlated to meat product measurements 252, such as meat size and composition measurements from harvested animals at maturity. These measurements may be obtained from measurements of live animals during growth. A target tissue composition (e.g., fat ratio) may also be considered and evaluated in encouraging and scheduling tissue growth.

The feed formulation system 220 may also develop the feed formulation 228 in the context of byproducts or second order effects, such as environmental measurements. For instance, the deployment of certain nutrients or materials may result in increased waste discharge and waste byproducts (including increased nitrogen or phosphorus released into water). The feed formulation system 220 may consider the environmental outcomes and provide different rations, feeding methods, and formulations for ongoing or forecasted feeding programs.

The feed formulation system 220 operates the effective energy model 232 which dynamically identifies nutritional requirements and formulation recommendations based on the evaluation of animal and feed data to evaluate essential nitrogenous energy that produces tissue growth (“effective energy”). The feed formulation system 220 may obtain data related to an animal population (e.g., a salmon population) including physiological conditions (e.g., weight, size, growth rate, etc.). This data may be collected using non-invasive measurement tools. For example, a near-infrared (NIR) or ultrasound imaging sensor may use spectral scanning to perform measurements of muscle or fat tissues. As another example, visible imaging (e.g., using RGB cameras) may produce images that identify characteristics of the body shape or composition of the animal, or identify features such as disease, damage or injury, etc. Other forms of non-invasive monitoring (e.g., weight, size measurements, etc.) may be provided with electrical, mechanical, or human-controlled mechanisms.

In some aspects, these measurements may be provided to the feed formulation system 220 to evaluate nutritional requirements and effective energy consumption for the animal population. For instance, based on a specified growth target for the animal population, the feed formulation system 220 may analyze different feed formulations, composed from different raw materials, to identify which materials may provide an optimum tissue growth to encourage a desired tissue composition at a desired growth rate. Such growth is not necessarily linear, but may occur with different formulations at different ages in the lifecycle of the animal population, and based on properties or characteristics of the site such as seasonality or temperature. Thus, different amounts, types, and schedules of animal feeds may be calculated.

The feed formulation system 220 may analyze data relating to feed ingredients which are provided by a feed information source. For instance, the feed information source may include supply data which indicates the type and amount of individual raw materials and nutritional ingredients for a feed mix, and schedule data which indicates availability and cost of individual ingredients or groupings of ingredients. The feed formulation may select or analyze the supply data, the schedule data, based on one or more specifications. For example, the specifications may indicate restrictions or preferences on the ingredients that are available for use and formulation at the production site. Other information associated with an animal producer, customer, or production location may also be used to specify the supply data and the schedule data. More details about the feed formulation system 220 and the effective energy model 230 may be found in the Appendix filed herewith.

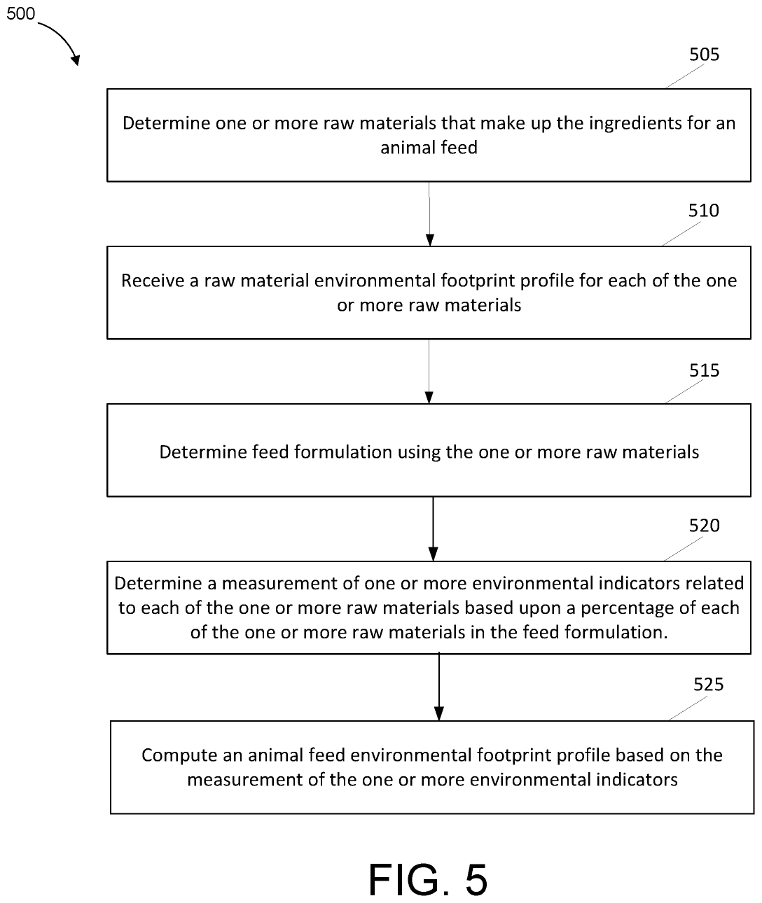

The animal feed environmental footprint profile 204 may be created based on feed formulation 228. More specifically, the environmental footprint prediction application 135 may receive an animal feed formulation and develop the animal feed environmental footprint profile 204 based on environmental indicators associated with the animal feed. The process for creating the animal feed environmental footprint profile 204 is described in more detail with respect to FIG. 5. In some aspects, LCA may be used to create the animal feed environmental footprint profile 204. In some aspects, additional inputs may be used to create the animal feed environmental footprint profile 204 including but not limited to: a transportation input (e.g., inbound transportation of raw materials to feed mill and outbound transportation input to the animal production facility), a feed processing input (e.g., water used to create feed, packaging used to wrap up feed for transport, and waste produced from processing the feed), and a raw materials input.

During the animal production 234, the animal production and processing environmental footprint profile 206 may also be created. The animal production and processing environmental footprint profile 206 may describe the environmental impact of the animal production process. Similar to the raw material environmental footprint profile 202 and the animal feed environmental footprint profile 204, the animal production and processing environmental footprint profile 206 may be determined based on one or more inputs which are described in more detail below. The inputs may be used to define one or more environmental indicators which may be added together to create the animal production and processing environmental footprint profile 206. In some aspects, the environmental indicators for creating the animal production and processing environmental footprint profile may be similar to the environmental indicators described above with respect to the animal feed environmental footprint profile.

Multiple inputs may be entered into the environmental footprint prediction application 135 in order to create the animal production and processing environmental footprint profile 206. In some aspects, a transportation input 236 may be used to create the animal production and processing environmental footprint profile 206. The transportation input 236 may be described as the mechanism in which environmental information about the transportation used during animal production and processing may be obtained. For example, the transportation input 236 may describe the emissions related to transporting the animals from a facility in which they are produced to a facility in which they may be processed or sold. In some aspects, the transportation input 236 may include information about distance traveled, time traveled, fuels used, etc. Information received from the transportation input 236 may include mode of transportation, the fuel source used, the distance traveled, the type of vehicle, the loading factor, intermediary storage, refrigeration during travel, and/or the duration of travel. The environmental footprint prediction application 135 may then compare the transportation information to a transportation database which describes emissions related to different modes of travel by fuel used, distance traveled, and/or any other transportation information. For example, a certain distance traveled may equal to a certain amount of fuel used and a certain amount of emissions produced. This information may be used to determine environmental indicators including global warming potential, land use/land use change, and fossil fuel resource scarcity indicators that may be used to create the animal production and processing environmental footprint profile.

In some aspects, a chemical input 238 may be used to create the animal production and processing environmental footprint profile 206. The chemical input 238 may include information about the chemicals (e.g., oxygen, soap, detergent, hydrogen peroxide, sodium hydroxide, acids, etc.) used during the animal production process. Certain chemical may be used during the animal production process for pest/parasite control, detergent, and disinfecting agents. The chemical input 238 may be entered as an amount and type of chemical. The chemical amount and type may then be compared to a chemical database to describe one or more environmental indicators including toxicity associated with the chemical, the global warming potential of the chemical, the natural resources used to create the chemicals, the water consumption used to create the chemical, etc.

In some aspects, an energy input 240 may be used to create the animal production and processing environmental footprint profile 206. The energy input 240 may include information about the energy used during the animal production 234. The energy input 240 may include information about the energy source (e.g., fossil fuel, biomass, renewable, nuclear, etc.), electricity used (e.g., origin and/or market mix of the electricity), type of diesel used (e.g., delice, wellboat, conventional, and/or marine gasoil) and the amount of energy used. The energy source and amount may compared to an energy source database to describe one or more environmental indicators including but not limited to global warming potential of the energy source, land use/land use change from producing the energy source, water consumption from producing the energy source, etc. related to using a particular energy source.

In some aspects, a facilities input 242 may be used to create the animal production and processing environmental footprint profile 206. The facilities input 242 may describe one or more site parameters that describe an animal production site. These site parameters include materials used in the animal production facilities (e.g., steel, concrete, plastic, timber, etc.), the lifespan of the facilities and the architecture of the facilities. These site parameters may be used to determine one or more environmental indicators including but not limited to global warming potential, land use/land use change, water consumption, etc. For example, the emissions produced while creating certain materials may be stored in one or more databases. These emissions along with the facilities lifespan may be input into the environmental footprint prediction application 135 to determine an emissions produced per period of time for each material.

In some aspects, a life stage input 244 may be used to create the animal production and processing environmental footprint profile 206. The life stage input 244 may describes the emissions related to the life stages that an animal may go through. For example, the transportation input 236, the chemical input 238, the energy input 240, the facilities input 242, a parasite control input 246, and an other input 248 may only describe the environmental impact of a fish in a grower (e.g., growing adult) phase. Salmon may go through three life stages before they are ready for harvest. These life stages are: 1) The egg phase, 2) the smolt phase, and 3) the grower phase. The life stage input 244 may include environmental indicators associated with the first two life stages which may not be reflected in the accounted for within the other inputs. These first two life stages may not be accounted for because a salmon farmer may purchase salmon to grow in their salmon farm when the fish are already in their later life stages. The life stage input 244 may receive a variety of information about the environmental impact of one or more life stages of the fish. For example, the information about the smolt lifestage may include the production type of the smolt (e.g., was the smolt produced in a net pen environment or a recirculation aquaculture system?), the year class of when the smolt was produced, the facility in which the smolt was produced, the equipment used to produce the smolt, the chemicals used to produce the smolt, the feed given to the smolt, the energy used to create the smolt, and the water used to create the smolt. As another example, the information about the grower life stage may include how the grower were produced, the facility in which the grower was produced, the equipment used to produce the grower, the chemicals used to produce the grower, the cleaner fished used to produce the grower, the feed given to the grower, the waste handling from the grower, the service companies used to produce the grower, the energy used to create the grower, and the water used to create the grower, which may then be compared to one or more databases to determine one or more environmental indicators associated with the particular life stage of the fish. For example, during the smolt phase, a particular type of feed may be used. The environmental information associated with this particular feed may be entered as information into the life stage input 244. Then, the environmental footprint prediction application 135 may determine environmental indicators similar to those described above with reference to the animal feed environmental footprint profile 204 for the feed used during the smolt phase. In some aspects, the animal production and processing environmental footprint profile 206 may be produced a single life stage of the fish, a subset of life stages of the fish, or all the life stages of the fish. Table 6 shown below describes other information other the smolt feed formulation that may obtained by the life stage input 244.

In some aspects, the parasite control input 246 may be used to create the animal production and processing environmental footprint profile 206. Parasite control within salmon production may be done in two ways. In some aspects, the parasite control may be done by cleaner fish which are released into salmon farming pens to eat parasites (e.g., sea lice) within the salmon pen. In other aspects, the parasite control may be done by chemicals released into the salmon farming pens to kill the parasites. The parasite control input 246 may include information about the environmental indicators related to either the cleaner fish or the chemical used for parasite control that may be used to create the animal production and processing environmental footprint profile 206. If a cleaner fish is used, additional information may be entered into the parasite control input 246 including but not limited to: production type of the cleaner fish (e.g., caught or produced?), the building construction of the facility used to produce the cleaner fish, the equipment used to produce the cleaner fish, the chemicals used to produce the cleaner fish, the feeds used to produce the cleaner fish, the energy used to produce the cleaner fish, the water used to produce the cleaner fish, and the waste handling of the cleaner fish. The following parameters may considered for determining the environmental impact of the building and facilities used during production of the cleaner fish: the material used to construct the building (e.g., steel, ceramics, gravel, water, plastic, cement/concrete, plaster, wood, etc.) and the energy used to construct the building and facilities. The following parameters may considered for determining the environmental impact of the equipment used during production of the cleaner fish: the material used to create the equipment (e.g., steel, ceramics, gravel, water, plastic, cement/concrete, plaster, wood, etc.) and the energy used to create the equipment. In some aspects, the environmental impact of the waste handling aspect of the cleaner fish production process may be based on the waste created (e.g., water, sludge/silage/manure, biological waste, paper products, metal, glass, mixed waste, oil/fuel, electric/appliance waste, etc.). If manure is created, additional information about the excretion, storage and processing, and application of the manure may be also entered through the parasite control input 246. In some aspects, the other input 248 may be used to create the animal production and processing environmental footprint profile 206. The other input 248 may include information about other environmental indicators that may not be described herein. For example, during the animal production process, services (e.g., chemicals, energy use, water use, and waste handling) may be provided by third parties through the other input. Once all the environmental indicators have been received through inputs 236-248, all the environmental indicators are added up to create the animal production and processing environmental footprint profile 206. In some aspects, LCA may be used to create the animal production and processing environmental footprint profile 206.

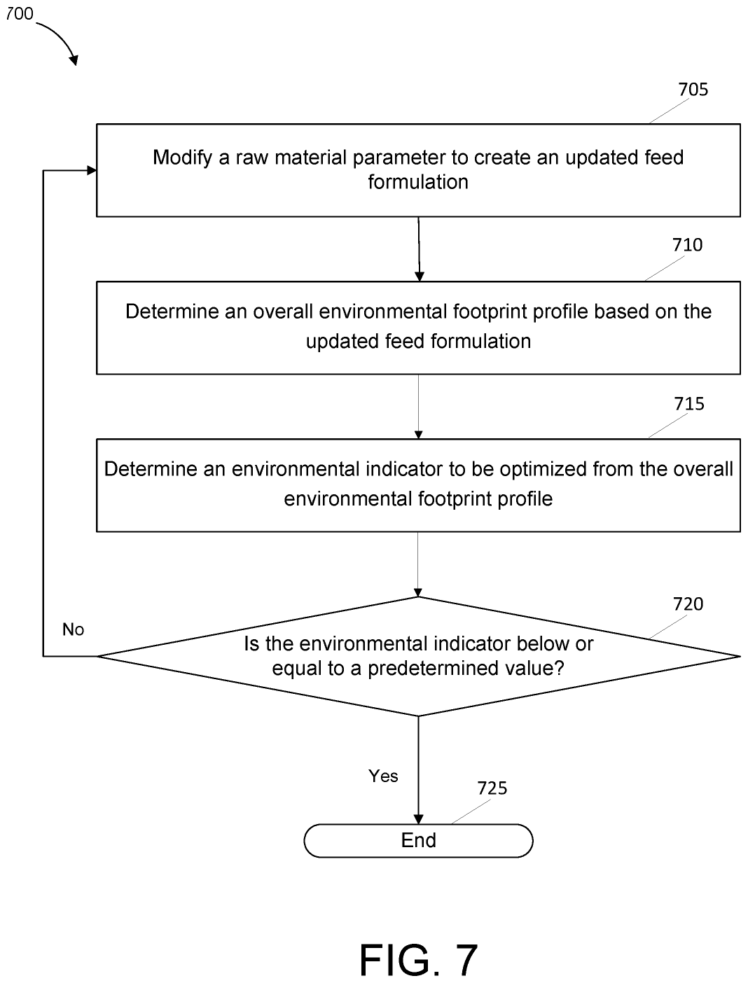

The overall environmental footprint profile 208 may be a summation of the raw material environmental footprint profile 202, the animal feed environmental footprint profile 204, and the animal production and processing environmental footprint profile 206. Additionally, environmental waste measurements 250 may also be added to the overall environmental footprint profile 208. The environmental waste measurements 250 may be byproducts or environmental waste produced during the animal production process. For instance, the deployment of certain nutrients or materials may result in increased waste discharge and waste byproducts (including increased nitrogen or phosphorus released into water). In some aspects, the feed formulation 228 may be adjusted based on the overall environmental footprint profile 208. The process for adjusting the feed formulation 228 based on the overall environmental footprint profile 208 is explained is in more detail below with respect to FIG. 7.

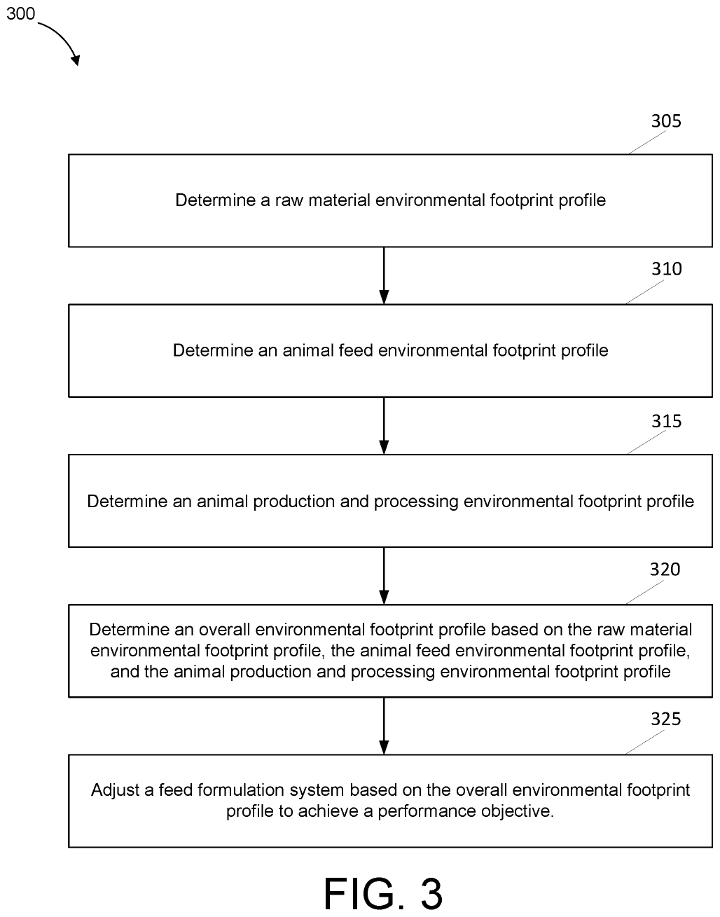

Referring now to FIG. 3, an example flowchart outlining operations of a process 300 is shown, in accordance with some aspects of the present disclosure. The process 300 may be implemented by the environmental footprint prediction application 135. The process 300 may be configured to create the overall environmental footprint profile 208 described above.

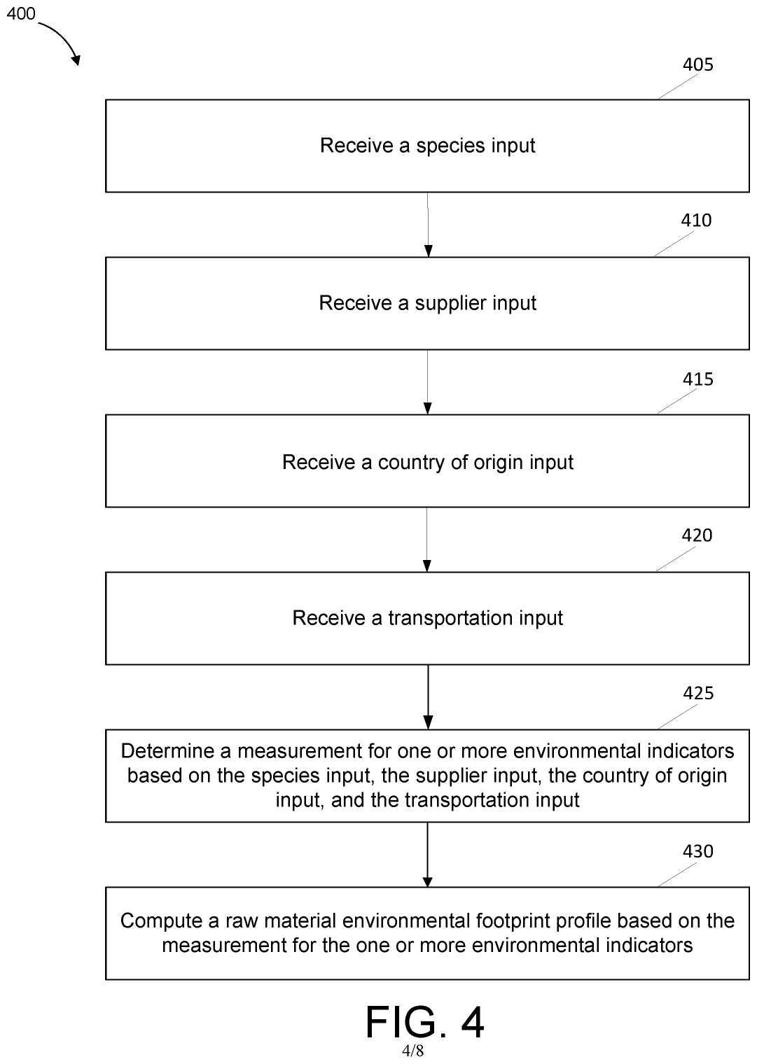

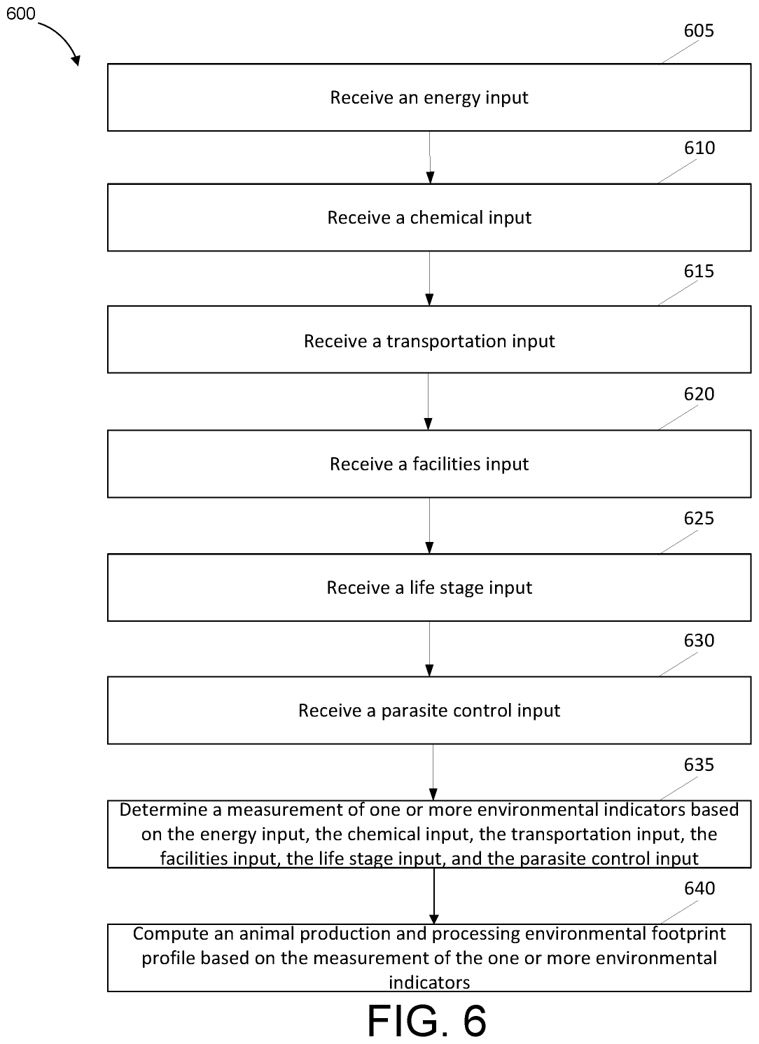

The process 300 begins at operation 305 with the environmental footprint prediction application 135 determining the raw material environmental footprint profile 202. As described above, the raw material environmental footprint profile 202 describes the environmental footprint of a raw material 210 that may be used as ingredients within an animal feed. The process for determining the raw material environmental footprint profile 202 is described in more detail below with respect to FIG. 4. At operation 310, the environmental footprint prediction application 135 determines the animal feed environmental footprint profile 204. As described above, the animal feed environmental footprint profile 204 describes the environmental footprint of an animal feed formulation. The process for determining the animal feed environmental footprint profile 204 is described in more detail below with respect to FIG. 5. At operation 315, the environmental footprint prediction application 135 determines the animal production and processing environmental footprint profile 206. As described above, the animal production and processing environmental footprint profile 206 describes the environmental footprint of an animal production process. The process for determining the animal production and processing environmental footprint profile is described in more detail below with respect to FIG. 6.

At operation 320, the environmental footprint prediction application 135 determines the overall environmental footprint profile 208 based on the raw material environmental footprint profile 202, the animal feed environmental footprint profile 204, and the animal production and processing environmental footprint profile 206. More specifically, the environmental footprint prediction application 135 may add the raw material environmental footprint profile 202, the animal feed environmental footprint profile 204, and the animal production and processing environmental footprint profile 206 together in order to create the overall environmental footprint profile 208. The environmental footprint prediction application 135 adds each individual environmental indicator from each of the raw material environmental footprint profile 202, the animal feed environmental footprint profile 204, and the animal production and processing environmental footprint profile 206 to each other such that similar indicators are added together to create the overall environmental footprint profile 208. For example, the land use change indicator from each of the raw material environmental footprint profile 202, the animal feed environmental footprint profile 204, and the animal production and processing environmental footprint profile 206 may be summed to obtain the land use change indicator for the overall environmental footprint profile 208. Similarly, the other environmental indicators from each of the raw material environmental footprint profile 202, the animal feed environmental footprint profile 204, and the animal production and processing environmental footprint profile 206 may be summed to obtain the various environmental indicators for the overall environmental footprint profile 208

Once the overall environmental footprint profile 208 is created, the environmental footprint prediction application 135 may adjust the feed formulation system 220, at operation 325, based on the overall environmental footprint profile 208 determined at the operation 320. More specifically, the feed formulation system 220 may be adjusted to achieve a performance objective. In some aspects, the performance objective may be to maximize the animal production efficiency (e.g., maximize the amount of animals produced during the animal production process). In other aspects, the performance objective may be to maximize the economic efficiency of the animal production process (e.g., maximize the amount of animals produced while minimizing the amount of capital expended during the animal production process. In some aspects, the performance objective may be to minimize the environmental footprint produced by an animal production process. For example, a salmon producer may wish to keep environmental emissions under a predetermined threshold of 4 kg CO₂ per 1 kg of salmon. The salmon producer may enter their performance objective into the computing system 100. The computing system may then continue the cycle of adjusting the feed formulation system until the overall emissions were below the predetermined threshold. The operation of adjusting the feed formulation system to achieve the performance objective of minimizing the environmental footprint or emissions produced by an animal production process is explained in more detail with respect to FIG. 7.

Referring now to FIG. 4, an example flowchart outlining operations of a process 400 is shown, in accordance with some aspects of the present disclosure. The process 400 may be implemented by the environmental footprint prediction application 135. The process 400 may be configured to create the raw material environmental footprint profile 202. The raw material environmental footprint profile 202 describes the environmental impact of producing a raw material that may be used within an animal feed from the beginning of the process to end. For example, if a plant raw material (e.g., corn, soybeans, wheat, seeds, etc.) is being produced, then the raw material environmental footprint profile 202 may describe emissions related to tilling the land for growing the plant, growing the plant, harvesting the plant, and processing the plant (e.g., drying, grinding, concentrating, cooking, etc.). Additionally, the raw material environmental footprint profile 202 may describe other environmental indicators (e.g., the land use, the water use, the natural resource, toxicity levels, stratospheric impacts, etc.) created as a byproduct of producing a raw material. In another example, if an animal raw material (e.g., fish) is being produced, then the raw material environmental footprint profile 202 may describe emissions related to each life stage of raising the animal, harvesting the animal, and processing the harvested animal (e.g., drying, preserving, grinding, etc.). Additionally, the raw material environmental footprint profile may include any emissions related to transportation of the raw material either within the raw material production process (e.g., transporting grain from field to silo) or to the raw materials final destination (e.g., feed mill, animal production facility).

The raw material environmental footprint profile 202 may be created by receiving one or more inputs, using those inputs to determine one or more environmental indicators associated with manufacturing the raw material, and then combining the environmental indicators to create the raw material environmental footprint profile 202. In some aspects, the environmental indicators may be similar to the environmental indicators shown in Table 1. Thus the process 400 begins at operation 405 with the environmental footprint prediction application 135 receiving the species input 212 related to a raw material species, as discussed above. In some aspects, the species input 212 may be used to determine a measurement for one or more environmental indicators related to the raw material using one or more databases as explained in more detail above with respect to FIG. 2.

At operation 410, the environmental footprint prediction application 135 receives the supplier input 214 related to a raw material supplier. The supplier input 214 is described in more detail above with respect to FIG. 2. In some aspects, the supplier input may help determine the measurement of one or more environmental indicators (e.g., emissions, global warming, water use, natural resource, etc.) related to the raw material. In some aspects, the supplier input 214 may be used to determine one or more environmental indicators related to the raw material using one or more databases as explained in more detail above with respect to FIG. 2.

At operation 415, the environmental footprint prediction application 135 receives the country of origin input 216 related to a country of origin of the raw material. In some aspects, the country of origin input 216 receives information about where the raw material was produced which may help determine a measurement for one or more environmental indicators for a raw material based on where the raw material was produced. The country of origin input 216 is explained in more detail above with respect to FIG. 2. In some aspects, the country of origin input 216 may be used to determine one or more environmental indicators related to the raw material using one or more databases as explained in more detail above with respect to FIG. 2.

At operation 420, the environmental footprint prediction application 135 receives the inbound transportation input 218 related to transportation of the raw material. The inbound transportation input 218 is described in more detail above with respect to FIG. 2. In some aspects, the inbound transportation input 218 receives information about the transportation of the raw material. In some aspects, the transportation input may be used to determine one or more environmental indicators related to the raw material using one or more databases as explained in more detail above with respect to FIG. 2.

Once the species input 212, the supplier input 214, the country of origin input 216, and the inbound transportation input 218 have been received by the environmental footprint prediction application 135, the process 400 proceeds to operation 425. At the operation 425, the environmental footprint prediction application 135 determines a measurement for one or more environmental indicators based on the species input 212, the supplier input 214, the country of origin input 216, and the inbound transportation input 218. More specifically, the one or more environmental indicators may be determined in one of two ways in some aspects. In one aspect, the environmental footprint prediction application 135 may use the information received from at least one of the species input 212, the supplier input 214, the country of origin input 216, and the inbound transportation input 218 to determine identifying information about the raw material. The environmental footprint prediction application 135 may then take this identifying information and compare it to one or more databases to determine a measurement of one or more environmental indicators related to the raw material. For example, the species input may indicate that the raw material is corn, the country of origin input may indicate that the corn was grown in the United States, and the transportation input may determine that the corn was transported 100 miles by a truck fueled by diesel. The environmental footprint prediction application 135 may take this information and determine the emissions which is a measurement of an environmental indicator (e.g., a global warming indicator) related to growing corn in the United States in a database which describes an emission related to various species of crops produced in various areas. Additionally, the environmental footprint prediction application 135 may look up the emissions related to transporting raw materials 100 miles by a truck fueled by diesel in a database which describes emissions related to different modes of travel by fuel used and distance traveled. In this case, the environmental footprint prediction application 135 determines two measurements of environmental indicators: one global warming indicator measurement related to the production of the raw material and one global warming indicator measurement related to the transportation of the raw material. In some aspects, the one or more databases may be stored in the memory 145 or received from an external source.

In another aspect, the one or more measurements of an environmental indicator may be determined directly from the supplier input as described above with respect to FIG. 2. For example, if the raw material is received from a supplier that tracks the emissions produced by manufacturing the raw material, the supplier may provide this information directly to a user such as salmon farmer who may then input the emission through input devices 115. Since the emission in this case is directly provided, it may not be necessary to compare the information received through the species input, the supplier input, the country of origin input, and the transportation input to one or more databases in order to determine an emission of a raw material. In some aspects, even if the emissions produced by manufacturing the raw material are provided directly by the supplier, the emissions produced by transporting the raw material may still need to be determined in such a way as described above. In other aspects, the emission provided by the supplier may include the emissions produced by transporting the raw material and therefore does not need to be determined spate.

Once the measurement of the one or more environmental indicators is determined at the operation 425, the environmental footprint prediction application 135 computes the raw material environmental footprint profile 202 at operation 430 based on the measurement of the one or more environmental indicators determined at operation 425. The environmental footprint prediction application 135 creates the raw material environmental footprint profile 202 by combining the one or more environmental indicators determined at operation 425 to create a summary of the environmental impact of producing a raw material. More specifically, environmental indicators in each category may be added together to create an overall environmental indicator for each category. For example, if two measurements of a global warming indicator were determined at operation 425 (e.g., one measurement for the species and one measurement for the inbound transport), then the two measurements would be added to create one overall global warming indicator for the raw material environmental footprint profile 202.

In some aspects, more than one raw material environmental footprint profile may be created by the process 400. For example, if a feed formulation includes more than one raw material, a raw material environmental footprint profile may be determined for each of the raw materials. Though the operations and examples explained above describe using all of the inputs to create the raw material environmental footprint profile 202, in some aspects, only a subset of the inputs described above may be used to create the raw material environmental footprint profile 202.

Referring now to FIG. 5, an example flowchart outlining operations of a process 500 is shown, in accordance with some aspects of the present disclosure. The process 500 may be implemented by the environmental footprint prediction application 135. The process 500 may be configured to create the animal feed environmental footprint profile 204 described above. The animal feed environmental footprint profile 204 describes the environmental impact associated with producing an animal feed.

The process 500 begins at operation 505 with the environmental footprint prediction application 135 determining one or more raw materials that make up the ingredients for an animal feed. As described above, the animal feed may be comprised of a variety of raw materials based on an animal feed formulation. For example, an animal feed may include 60% com, 20% soybean meal, 10% fishmeal, and 10% soy bean oil. In this case, the environmental footprint prediction application 135 may determine that the animal feed may include the following raw materials: com, soybean meal, fishmeal, and soy bean oil. Additionally, the environmental footprint prediction application 135 may determine the relative amounts of each of the raw materials within the entire animal feed (i.e., percentage of the animal feed made up of the particular raw material.)

After determining the raw materials at operation 505, the environmental footprint prediction application 135 proceeds to operation 510 where the environmental footprint prediction application 135 receives one or more raw material environmental footprint profiles for each of the raw materials determined at operation 505. Referring back to the example above, the environmental footprint prediction application 135 may determine four raw material environmental footprint profiles, one for each of the raw materials in the animal feed (e.g., corn, soybean meal, fishmeal, and soybean oil). The raw material environmental footprint profiles(s) may be determined according to the process 400 described in the preceding paragraphs. The raw material environmental footprint profiles may be used to compute the animal feed environmental footprint profile as described in more detail below.

The animal feed environmental footprint profile may include a measurement of the environmental impact (e.g., measurement of one or more environmental indicators) related to creating the animal feed from the raw materials at an animal feed creation facility (e.g., feed mill). For example, creating an animal feed may require electricity to power one or more machines that process the raw materials to create the animal feed. The environmental impact of producing and using this electricity may be measured by one or more environmental indicators. Additionally, packaging and transporting the animal feed may also produce emissions which need to be accounted for in the animal feed environmental footprint profile. Operations 515-525 describes the process of accounting for these environmental impacts in more detail below.

At operation 515, the environmental footprint prediction application 135 determines a feed formulation using the one or more raw materials determined at the operation 505. Going back to the example above, this feed formulation may include 60% corn, 20% soybean meal, 10% fishmeal, and 10% soy bean oil. The feed formulation may give the environmental footprint prediction application 135 the information necessary to determine a measurement of one or more environmental indicators related to the animal feed as described below.

At operation 520, the environmental footprint prediction application 135 determines a measurement of one or more environmental indicators related to each of the one or more raw materials based upon a percentage of each of the one or more raw materials in the feed formulation. For example, let us say that corn has a global warming or emissions indicator of 2 kg. CO₂ eq. per kg. of raw material as described in corn's raw material environmental footprint profile. Additionally, the corn makes up 60% of the animal feed as described in the example animal feed formulation above. In this case, the animal feed would have an emission of 1.2 kg CO₂ eq. per kg (e.g., product of 60% and 2 kg. CO₂ eq. per kg) of animal feed which comes from com. This same calculation would be repeated for each individual type of raw material within the animal feed (e.g., 20% soybean meal, 10% fishmeal, and 10% soy bean oil). Though this calculation is shown as being done for a global warming indicator, this calculation may be done for any of the environmental indicators described with respect to Table 1 above.

Once the measurement of the one or more environmental indicators is determined at operation 520, the environmental footprint prediction application 135 computes the animal feed environmental footprint profile 204 at operation 525 based on the measurement of the one or more environmental indicators determined at operation 520. The environmental footprint prediction application 135 creates the animal feed environmental footprint profile 204 by combining the one or more environmental indicators determined at operation 520 to create a summary of the environmental impact of producing the animal feed. More specifically, environmental indicators in each category may be added together to create an overall environmental indicator for each category. For example, if two measurements of a global warming indicator were determined at operation 520, then the two measurements would be added to create one overall global warming indicator for the animal feed environmental footprint profile 204.

Referring now to FIG. 6, an example flowchart outlining operations of a process 600 is shown, in accordance with some aspects of the present disclosure. The process 600 may be implemented by the environmental footprint prediction application 135. The process 600 may be configured to create the animal production and processing environmental footprint profile 206 described above. The animal production and processing environmental footprint profile 206 describes the environmental impact associated with the animal production process including emissions produced by raising the animal from infancy to harvest.

The animal production and processing environmental footprint profile 206 is created by receiving one or more inputs, using those inputs to determine the environmental indicators associated with raising, harvesting, and processing animals, and then finally adding up the environmental indicators to create animal production and processing environmental footprint profile 206. The inputs received within process 600 provide environmental information related to one or more aspects of the animal production and processing process. More specifically, the inputs received within process 600 provide information that may allow the environmental footprint prediction application 135 to determine the environmental indicators that make up the animal production and processing environmental footprint profile 206 as described above.

Animal production and processing refers to raising animals from a beginning life stage (e.g., eggs, infancy, etc.) till an end life stage (e.g., adulthood), harvesting the animal, and then processing the animals harvested for consumption. In some aspects, the animal may be raised in one or more environments and using one or more methods. For example, salmon may be raised in a net pen environment wherein mesh enclosures are located in seas and oceans confining the salmon to the mesh enclosure. In this example, water is readily exchanged between the net pen where the salmon are located and the body of water the net pen is located. As another example, salmon may be raised in a recirculating aquaculture system wherein non-mesh enclosures (e.g., tanks, pools, etc), often located on land, where no water is exchanged with natural bodies of water such as oceans and seas. The process 600 may account for these different salmon production environments by changing the inputs (e.g., adding inputs, removing inputs, receiving different information from the inputs) discussed in further detail below based on the environment that the salmon are being raised in. Additionally, harvested salmon may be processed in different ways also leading to changing the inputs of process 600. For example, in some aspects, salmon may be head-on-gutted while the salmon may be headed and gutted in other aspects.

Thus the process 600 begins at operation 605 with the environmental footprint prediction application 135 receiving the energy input 240 related to an energy used during animal production and processing. The energy input 240 is described in more detail above with respect to FIG. 2. In some aspects, the information from the energy input 240 may be used to determine a measurement for one or more environmental indicators which may be used to create the animal production and processing environmental footprint profile 206. More details about this process are described above with respect to FIG. 2.

At operation 610, the environmental footprint prediction application 135 receives the chemical input 238 related to chemicals used during animal production and processing. The chemical input is described in more detail above with respect to FIG. 2. Chemicals may be used for a variety of reasons in the animal production process. For example, parasite killing chemicals such as azamethiphos and teflubenzuron may be used for parasite control. As another example, detergents and disinfecting agents such as hydrogen peroxide may be used to keep the salmon sanitary during salmon processing. The chemical input provides information about the chemicals used during animal production and processing. In some aspects, the information from the chemical input may be used to determine one or more environmental indicators which may be used to create the animal production and processing environmental footprint profile 206. More specifically, the chemical amount and type may be compared to a database to describe one or more environmental indicators including but not limited to the global warming indicator, the water consumption indicator, one or more stratosphere condition indicators, one or more acidification and eutrophication indicators, one or more toxicity indicators, and the mineral resource scarcity indicator.

At operation 615, the environmental footprint prediction application 135 receives the transportation input 236 related to chemicals used during animal production and processing. The transportation input 236 is described in more detail above with respect to FIG. 2. During the animal production process, the animal product may be transported. For example, harvested salmon may be transported from a production facility (e.g., a net pen environment or a recirculation aquaculture system) to a processing facility. As another example, salmon may need to be transported from one location of the production facility to another location of the production facility based on the life stage of the salmon. The transportation input provides information about the transportation used during animal production and processing. In some aspects, the information from the transportation input may be used to determine one or more environmental indicators which may be used to create the animal production and processing environmental footprint profile 206. More specifically, the transportation information may be compared to a database to describe one or more environmental indicators including but not limited to the global warming indicator, the land use/land use change indicator, one or more toxicity indicators, the fossil resource scarcity, and the mineral resource scarcity indicator.

At operation 620, the environmental footprint prediction application 135 receives the facilities input 242 related to the facilities in which animal production and processing takes place. The facilities input 242 is described in more detail above with respect to FIG. 2. The animal production facilities are created from natural resources and their derivatives (e.g., steel, timber, cement, etc.) and often require fossil fuels to power their construction. In some aspects, the information from the facilities input 242 may be used to determine one or more environmental indicators which may be used to create the animal production and processing environmental footprint profile 206. More specifically, the facilities information may be compared to a database to describe one or more environmental indicators including but not limited to the global warming indicator, the land use/land use change indicator, one or more toxicity indicators, the fossil resource scarcity, and the mineral resource scarcity indicator.

At operation 625, the environmental footprint prediction application 135 receives the life stage input 244 related to the life stage of the animal within the animal production process. As described above, an animal may go through multiple life stages before being harvested and processed. For example, during a salmon production process, a salmon may go through three life stages: 1) The egg phase, 2) the smolt phase, and 3) the grower phase. The life stage input may receive environmental information related to the egg phase or the smolt phase. In some aspects, the information from the life stage input may be used to determine one or more environmental indicators which may be used to create the animal production and processing environmental footprint profile 206. More specifically, the life stage information may be compared to a database to describe one or more environmental indicators including but not limited to the global warming indicator, the land use/land use change indicator, one or more toxicity indicators, the fossil resource scarcity, and the mineral resource scarcity indicator.

At operation 630, the environmental footprint prediction application 135 receives a parasite control input 246 related to one or more parasite control methods used within the animal production process. The parasite control input 246 is described in more detail above with respect to FIG. 2. Salmon may be infected with a variety of different parasites parasite control methods are not implemented in the salmon production process. For example, salmon may be infected with worms, sea lice, bacteria, etc. Salmon farmers may utilize parasite control methods such as cleaner fish and chemical treatments to prevent parasites and diseases from infecting the salmon. The parasite control methods may contribute the environmental footprint based on the chemicals used and/or the cleaner fish raised. For example, as described above, a chemical may have one or more environmental indicators (e.g., toxicity indicators) that describe the environmental impact of using chemicals as a parasite control method. As another example, a cleaner fish may have one or more environmental indicators that describe the environmental impact of producing the cleaner fish. In some aspects, the information from the parasite control input may be used to determine one or more environmental indicators which may be used to create the animal production and processing environmental footprint profile 206. More specifically, the parasite control information may be compared to a database to describe one or more environmental indicators including but not limited to the global warming indicator, the land use/land use change indicator, one or more toxicity indicators, the fossil resource scarcity, and the mineral resource scarcity indicator.

Once the energy input 240, the chemical input 238, the transportation input 236, the facilities input 242, the life stage input 244, and the parasite control input 246 have been received by the environmental footprint prediction application 135, the process 600 proceeds to operation 635. At operation 635, the environmental footprint prediction application 135 determines a measurement for one or more environmental indicators based on the energy input 240, the chemical input 238, the transportation input 236, the facilities input 242, the life stage input 244, and the parasite control input 246. In some aspects, the environmental footprint prediction application 135 may use the information received from at least one of the energy input 240, the chemical input 238, the transportation input 236, the facilities input 242, the life stage input 244, and the parasite control input 246 to determine one or more environmental indicators associated with the animal production process. More specifically, information from the inputs described above may be compared to one or more databases that store environmental information that may be used to determine the measurement of the one or more environmental indicators.

Once the one or more emissions is determined at operation 635, the environmental footprint prediction application 135 computes an animal production and processing environmental footprint profile 206 based on the measurement of the one or more environmental indicators determined at operation 640. More specifically, the environmental footprint prediction application 135 creates the animal production and processing environmental footprint profile 206 by combining the one or more environmental indicators determined at operation 635 to create a summary of the environmental impact of the animal production and processing process. More specifically, environmental indicators in each category may be added together to create an overall environmental indicator for each category. For example, if two measurements of a global warming indicator were determined at operation 520, then the two measurements would be added to create one overall global warming indicator for the animal feed environmental footprint profile 204.

Referring now to FIG. 7, an example flowchart outlining operations of a process 700 is shown in accordance with some aspects of the present disclosure. The process 700 may be implemented by the environmental footprint prediction application 135. The process 700 may be configured to iteratively adjust a feed formulation to minimize the environmental footprint or emissions produced by an animal production process. The process 700 may be executed by the environmental footprint prediction application 135 directly following operation 325 of process 300.

At operation 705, the environmental footprint prediction application 135 modifies a raw material parameter within a feed formulation. In some aspects, the raw material parameter may include an inclusion rate. The inclusion rate may refer to what percentage of the animal feed is made up of a particular raw material. In some aspects, the environmental footprint prediction application 135 may modify the raw material parameter by increasing or decreasing inclusion rate of one or more raw materials within an animal feed. In some aspects, the environmental footprint prediction application 135 may modify the raw material parameter by replacing one raw material for another. For example, instead of using corn within a feed formulation, wheat, oats, rice, or barley may be used.

At operation 710, the environmental footprint prediction application 135, determines an overall environmental footprint profiles based on the updated feed formulation. This operation may be very similar to operation 320 of process 300 as described above.

At operation 715, the environmental footprint prediction application 135 determines an environmental indicator to be optimized from the overall environmental footprint profile. As mentioned above, the feed formulation may be modified in order to meet a certain performance objective. More specifically, one or more environmental indicators may be optimized in order to meet the certain performance objective. For example, a salmon farmer may be interested in minimizing the environmental footprint and emissions produced by an animal production process. In this case, the farmer may choose to optimize (e.g., minimize) the global warming indicators and the land use change indicators within the overall environmental footprint profile in order to meet the performance objective.

At operation 720, the environmental footprint prediction application 135 determines whether the environmental indicator is below or equal to a predetermined value. More specifically, the environmental footprint prediction application 135 compares the environmental indicator determined at operation 715 to the emissions set as the predetermined value. If the environmental indicator determined at operation 715 is below or equal to the predetermined value, then the process 700 ends at operation 725. If the environmental indicator is not below the predetermined threshold, then the process 700 begins again at operation 705. The process 700 may be run multiple times until the environmental indicator determined at operation 715 is below the predetermined value thus making the process an iterative process. After running the process 700, the output from the overall environmental profile 208 and the effective energy model 232 may be evaluated. If one or more environmental indicators in the environmental profile 208 are not satisfactory, a user may reevaluate the feed formulation and/or other the animal production and processing and processing parameters and design a new scenario (e.g., new inputs that may be evaluated using processes 300, 400, 500, and 600 as described above). The new scenario may then be evaluated until a satisfactory result is reached. The new scenario may be used as the starting baseline recommendation for an animal production process. In some aspects, the process 700 may be executed during the animal production process to re-calibrate and adjust the overall environmental footprint profile 208 and the effective energy model 232. In some aspects, the process 700 produces a “predicted” overall environmental footprint profile based on inputs received by the environmental footprint prediction application 135. This predicted overall environmental footprint profile may then be compared to an actual environmental footprint profile as produced in process 300 to determine how accurate the predicted overall environmental footprint profile is.

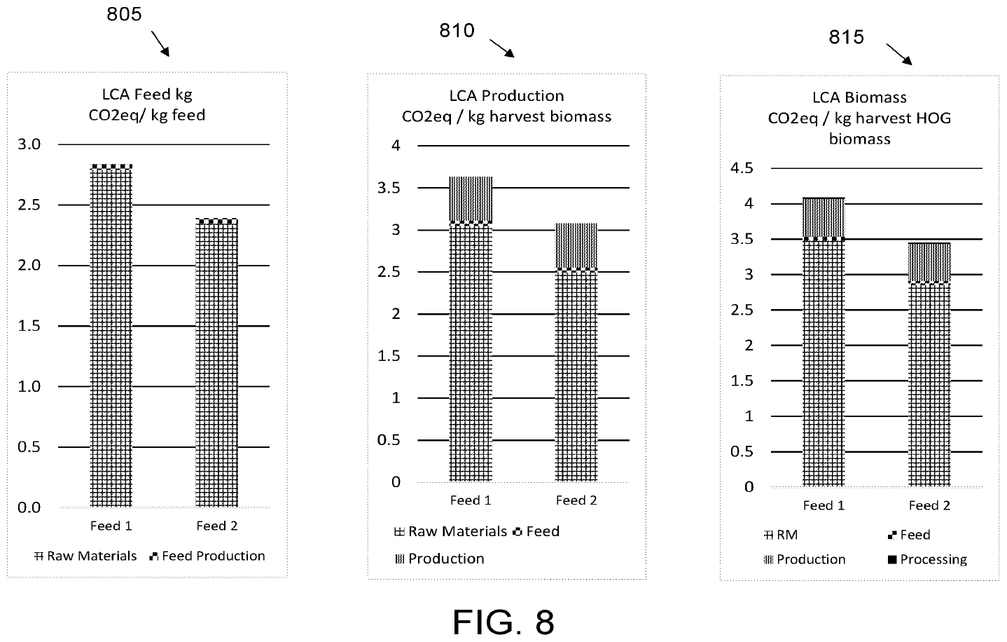

Referring now to FIG. 8, example graphs outlining an environmental impact of an animal production process is shown, in accordance with some aspects of the present disclosure. More specifically, the graphs 805, 810, and 815 show an example result of calculating the raw material environmental footprint profile 202, the animal feed environmental footprint profile 204, the animal production and processing environmental footprint profile 206, and the overall environmental footprint profile 208. In some aspects, the environmental footprint profiles begin to be created by describing a site at which the animal production process may take place. For example, the physical structure, the amount of animal produced, etc. may be described. In some aspects, Table 2 may also include a salmon feed LCA and a Salmon feed economic feed conversion rate (eFCR) as inputs though not shown below. A table showing the parameters that may be used to define an animal production site is shown below at Table 2.

TABLE 2
Example site parameters for an animal production process.

| | |
|---|---|
| Location: | Coordinates |
| Species: | What species are under investigation. In this example it will |
| | be Atlantic Salmon (ATS). |
| Temperature profile: | Temperature may be an important factor for how quick |
| | growth can happen. Each site may be assigned a temperature |
| | profile for a 12-month cycle. In our example we use the |
| | actual temperatures at the site in the previous year as our |
| | profile. |
| Smolt Use: | 0.026 kg / kg salmon produced |
| Raised cleaner fish used: | 0.02374 kg / kg salmon produced |
| Caught cleaner fish used: | 0 kg / kg salmon produced |
| Transport distance, cleaner | 500 km |
| fish: | |
| H²O²: | 0 kg / kg salmon produced |
| Fuel Use, Service Vessels: | 0.015 L diesel / kg salmon |
| Fuel Use, Wellboat: | 0.08 L heavy fuel oil / kg salmon |
| Fuel Use, Farm: | 0.04 L diesel / kg salmon |
| Electricity, Farm | 0.26 kWh / kg salmon |
| Transport to processing | 500 km by 5000 DWT ship |
| plant | |
| Site annual production | 3000 tons |
| Production Units: | Number of pens available at the site. |
| Pen size | 160 m diameter/20 pens |
| Lifespan of the facilities: | 10 years |
| Total polypropylene used at | 0.011 kg / year / kg salmon produced |
| site | |
| Total polyethylene used at | 0.011 kg / year / kg salmon produced |
| site | |
| Total high alloy steel | 0.0019 kg / year / kg salmon produced |
| Total low alloy steel | 0.0045 kg / year / kg salmon produced |

Once the site for animal production has been described, specific parameters for a particular life stage of the fish may also be described. In some aspects, only one life phase (e.g., the grower phase) may be described within the site parameters or throughout the other inputs received through the environmental footprint prediction system 200. Therefore particular parameters related to the life stage of the fish not provided by the other parameters or inputs may be needed to create the overall environmental footprint profile 208. In some aspects, Table 2 may also include a salmon feed LCA and a Salmon feed eFCR as inputs. In some aspects, in addition to providing the amount of water consumed as a parameter, the type of water consumed may also be provided. For example, whether the water is fresh water or salt water may be provided as a parameter in Table 2. Example life stage parameters for the smolt phase of the fish's life, which are not included in Table 2, are shown below in Table 3.

TABLE 3
Example life stage parameters for the smolt phase.

| | |
|---|---|
| Environmental profile of the | One feed for the entire smolt production may be assumed in |
| feed given | some aspects. Multiple feeding scenarios may be modeled |
| | similar to the grower phase described. |
| Economic FCR (eFCR) for | 1 kg / kg smolt produced |
| the feed used | |
| Site annual production | 5000 tons / year |
| Lifespan of the buildings at | 20 years |
| the facility | |
| Lifespan of the equipment at | 10 years |
| the facility | |
| Production area needed: | 3 m² / ton produced |
| Outside area factor | 2 - Adjustment factor for outside area. 2 for <5000 tons, 1.5 |
| | for >5000 tons |
| Total Concrete | 58 200 tons |
| Used/Concrete Conversion | 2360 kg/m³ |
| Factor | |
| Total Polyethylene Used | 809 tons |
| Total Steel Used | 1 430 tons |
| Total Fibreglass Used | 881 tons |
| Oxygen Use | 0.6 kg / kg feed given |
| Bicarbonate Use | 0.2 kg / kg feed given |
| Water Consumption | 400 L / kg feed given |
| Electricity use | 6 kWh / kg produced |
| Diesel use | 0.033 kg / kg produced |
| Sludge produced | 1.5 kg / kg produced (10% drymatter) |
| Electricity for sludge drying | 0.5 kWh / kg sludge (10% to 20% drymatter) |

Next, a raw material environmental footprint profile may be calculated for each of the raw materials in a feed composition based on the site parameters shown in Table 2, the smolt parameters shown in Table 3, and the raw materials used within an animal feed. An example raw material environmental footprint profile is shown below in Table 4.

TABLE 4
Example raw material environmental footprint
profile of a corn/maize raw material.

| Impact category | Unit | Total |
|---|---|---|
| Global warming - incl LUC | kg CO2 eq | 0.506960 |
| Global warming - excl LUC | kg CO2 eq | 0.470723 |
| Land Use Change (LUC) | kg CO2 eq | 0.036237 |
| Land use | m2a crop eq | 1.027885 |
| Water consumption | m3 | 0.002222 |
| Stratospheric ozone depletion | kg CFC11 eq | 0.000007 |
| Ionizing radiation | kBq Co-60 eq | 0.009988 |
| Ozone formation, Human health | kg NOx eq | 0.001151 |
| Fine particulate matter formation | kg PM2.5 eq | 0.000875 |
| Ozone formation, Terrestrial ecosystems | kg NOx eq | 0.001163 |
| Terrestrial acidification | kg SO2 eq | 0.005844 |
| Freshwater eutrophication | kg P eq | 0.000148 |
| Marine eutrophication | kg N eq | 0.002316 |
| Terrestrial ecotoxicity | kg 1,4-DCB | 0.062722 |
| Freshwater ecotoxicity | kg 1,4-DCB | 0.001301 |
| Marine ecotoxicity | kg 1,4-DCB | 0.001227 |
| Human carcinogenic toxicity | kg 1,4-DCB | 0.000161 |
| Human non-carcinogenic toxicity | kg 1,4-DCB | 1.128508 |
| Mineral resource scarcity | kg Cu eq | 0.000446 |
| Fossil resource scarcity | kg oil eq | 0.068456 |

Next, an animal feed formulation may be created to feed the animals described according to the site parameters shown in Table 2. For example, in Table 2, the amount of salmon produced in a year is 3000 tons. From this number it can be extrapolated that a certain amount and type of animal feed to produce 3000 tons of salmon a year. The process for creating an animal feed is explained in more detail above with respect to FIG. 2. An example feed formulation that may be used in this case is shown below in Table 5 below.

TABLE 5
Example feed formulation.

| Ingredient | Percent |
|---|---|
| Corn | 61.98 |
| Soybean Meal 46% | 30.48 |
| Soybean Oil | 4.11 |
| Limestone | 1.47 |
| Monodic. Phosphate | 0.88 |
| Salt | 0.46 |
| DL-Methionine 98% | 0.2435 |
| L-Lysine HCL 99% | 0.1519 |
| Choline 60% | 0.0998 |
| L-Threonine 98.5% | 0.0233 |
| Vitamin Premix | 0.05 |
| Micromin Premix | 0.05 |
| Carboh/Protease Blend | 0.01 |
| Phytase | 0.0029 |

An example animal feed environmental footprint profile may be created based on the raw material environmental footprint profile described in Table 4 and the animal feed described in Table 5. The example animal feed environmental footprint profile is shown below in Table 6.

TABLE 6
Example animal feed environmental footprint
profile for 1 kg of finished feed.

| Impact category | Unit | Total |
|---|---|---|
| Global warming - incl LUC | kg CO2 eq | 3.5454 |
| Global warming - excl LUC | kg CO2 eq | 2.1837 |
| Land Use Change (LUC) | kg CO2 eq | 1.3617 |
| Land use | m2a crop eq | 3.9957 |
| Water consumption | m3 | 1.0964 |
| Stratospheric ozone depletion | kg CFC11 eq | 0.0000 |
| Ionizing radiation | kBq Co-60 eq | 0.1066 |
| Ozone formation, Human health | kg NOx eq | 0.0089 |
| Fine particulate matter formation | kg PM2.5 eq | 0.0044 |
| Ozone formation, Terrestrial | kg NOx eq | 0.0092 |
| ecosystems | | |
| Terrestrial acidification | kg SO2 eq | 0.0214 |
| Freshwater eutrophication | kg P eq | 0.0011 |
| Marine eutrophication | kg N eq | 0.0069 |
| Terrestrial ecotoxicity | kg 1,4-DCB | 2.0670 |
| Freshwater ecotoxicity | kg 1,4-DCB | 0.0239 |
| Marine ecotoxicity | kg 1,4-DCB | 0.0181 |
| Human carcinogenic toxicity | kg 1,4-DCB | 0.0072 |
| Human non-carcinogenic toxicity | kg 1,4-DCB | 2.8839 |
| Mineral resource scarcity | kg Cu eq | 0.0024 |
| Fossil resource scarcity | kg oil eq | 0.4936 |

An example animal production and processing environmental footprint profile may be created based on the site parameters in Table 2, the life stage parameters in Table 3, and the processing parameters shown in Table 7 below. The processing parameters describe the environmental impact of processing (e.g., head-on-gutted processing) the animals produced during animal production process. The inputs in Table 8 below may be used to define the environmental impact of the processing the animals produced during the animal production process. The processing information may include inputs that describe the product type, yield, building and facilities used during processing, equipment used during processing, chemicals used during processing, energy used during processing, water used during processing, and waste handling during processing. The following parameters may be considered for determining the environmental impact of the building and facilities used during animal production: the material used to construct the building (e.g., steel, ceramics, gravel, water, plastic, cement/concrete, plaster, wood, etc.) and the energy used to construct the building and facilities. The following parameters may be considered for determining the environmental impact of the equipment used during animal production: the material used to create the equipment (e.g., steel, ceramics, gravel, water, plastic, cement/concrete, plaster, wood, etc.) and the energy used to create the equipment. In some aspects, the environmental impact of the waste handling aspect of the animal production process may be based on the waste created (e.g., water, sludge/silage/manure, biological waste, paper products, metal, glass, mixed waste, oil/fuel, electric/appliance waste, etc.) The example animal production and processing environmental footprint profile is shown in Table 8 below.

TABLE 7
Example processing parameters

| | |
|---|---|
| Electricity | 0.1284 kWh / kg HOG |
| Diesel | 0.000155 kg / kg HOG |
| Detergent | 0.0003 kg / kg HOG |
| Water Consumption | 6.1 kg / kg HOG |
| Production area needed: | 0.0000067 m2/ kg HOG |

TABLE 8
Animal processing inputs and their units
for head-on-gutted processing.

| | |
|---|---|
| Yield | % of round weight |
| Salmon | kg / kg head-on-gutted |
| Electricity | kWh/kg head-on-gutted |
| Diesel | kg diesel / kg head-on-gutted |
| Detergent | kg / kg head-on-gutted |
| Water consumption | L / kg head-on-gutted |
| Building facilities, wooden | m² / head-on-gutted |
| Building facilities, steel | m² / head-on-gutted |

TABLE 9
Example animal production and processing environmental
footprint profile for 1 kg of head-on-gutted salmon.

| Impact category | Unit | Total |
|---|---|---|
| Global warming - incl LUC | kg CO2 eq | 0.5419 |
| Global warming - excl LUC | kg CO2 eq | 0.5408 |
| Land Use Change (LUC) | kg CO2 eq | 0.0011 |
| Land use | m2a crop eq | 0.0068 |
| Water consumption | m3 | 3.3842 |
| Stratospheric ozone depletion | kg CFC11 eq | 0.0000 |
| Ionizing radiation | kBq Co-60 eq | 0.0393 |
| Ozone formation, Human health | kg NOx eq | 0.0064 |
| Fine particulate matter formation | kg PM2.5 eq | 0.0021 |
| Ozone formation, Terrestrial ecosystems | kg NOx eq | 0.0065 |
| Terrestrial acidification | kg SO2 eq | 0.0063 |
| Freshwater eutrophication | kg P eq | 0.0001 |
| Marine eutrophication | kg N eq | 0.0000 |
| Terrestrial ecotoxicity | kg 1,4-DCB | 1.2357 |
| Freshwater ecotoxicity | kg 1,4-DCB | 0.0069 |
| Marine ecotoxicity | kg 1,4-DCB | 0.0137 |
| Human carcinogenic toxicity | kg 1,4-DCB | 0.0248 |
| Human non-carcinogenic toxicity | kg 1,4-DCB | 0.1577 |
| Mineral resource scarcity | kg Cu eq | 0.0046 |
| Fossil resource scarcity | kg oil eq | 0.2691 |

Tables 6 and 9 may be added together to create an overall environmental footprint profile which is shown in Table 10 below.

TABLE 10
Example of overall environmental footprint
profile for 1kg of head-on-gutted salmon.

| Impact category | Unit | Total |
|---|---|---|
| Global warming - incl LUC | kg CO2 eq | 4.0873 |
| Global warming - excl LUC | kg CO2 eq | 2.7245 |
| Land Use Change (LUC) | kg CO2 eq | 1.3628 |
| Land use | m2a crop eq | 4.0025 |
| Water consumption | m3 | 4.4806 |
| Stratospheric ozone depletion | kg CFC11 eq | 0.0000 |
| Ionizing radiation | kBq Co-60 eq | 0.1459 |
| Ozone formation, Human health | kg NOx eq | 0.0153 |
| Fine particulate matter formation | kg PM2.5 eq | 0.0065 |
| Ozone formation, Terrestrial ecosystems | kg NOx eq | 0.0157 |
| Terrestrial acidification | kg SO2 eq | 0.0277 |
| Freshwater eutrophication | kg P eq | 0.0011 |
| Marine eutrophication | kg N eq | 0.0070 |
| Terrestrial ecotoxicity | kg 1,4-DCB | 3.3027 |
| Freshwater ecotoxicity | kg 1,4-DCB | 0.0308 |
| Marine ecotoxicity | kg 1,4-DCB | 0.0318 |
| Human carcinogenic toxicity | kg 1,4-DCB | 0.0320 |
| Human non-carcinogenic toxicity | kg 1,4-DCB | 3.0416 |
| Mineral resource scarcity | kg Cu eq | 0.0070 |
| Fossil resource scarcity | kg oil eq | 0.7628 |

The graphs shown in FIG. 8 show the result of adding the global warming environmental indicators described in Tables 6 and 9 above to determine an overall global warming environmental indicator as described in Table 10 and as shown in graph 815. As we can see in FIG. 8, the raw materials make up a majority of the emissions within the overall global warming environmental indicator. Therefore by adjusting or modifying the animal feed as described in FIG. 7 and re-determining the overall environmental footprint profile, a salmon farmer may determine which animal feed belier fits their performance objective. For example, in FIG. 8, Feed 1 has a higher global warming environmental indicator. So if the salmon farmer's objective was to lower the emissions of their salmon production process, they would accept Feed 2, or continue to iterate to further reduce the emission number. Though the global warming environmental indicator is used as an example in FIG. 8, please note that any of the environmental indicators shown in Tables 6 and 9 may be added together to create graphs similar to graphs 805, 810, and 815.

The various illustrative logical blocks, circuits, modules, routines, and algorithm steps described in connection with the aspects disclosed herein may be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality may be implemented in varying ways for each particular application, but such implementation decisions should not be interpreted as causing a departure from the scope of the disclosure.

Moreover, the various illustrative logical blocks and modules described in connection with the aspects disclosed herein may be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor may synthesize a model for an FPGA. For example, the control processor may synthesize a model for logical programmable gates to implement a tensor array and/or a pixel array. The control channel may synthesize a model to connect the tensor array and/or pixel array on an FPGA, a reconfigurable chip and/or die, and/or the like. A general purpose processor device may be a microprocessor, but in the alternative, the processor device may be a controller, microcontroller, or state machine, combinations of the same, or the like. A processor device may include electrical circuitry configured to process computer-executable instructions. In another aspect, a processor device includes an FPGA or other programmable device that performs logic operations without processing computer-executable instructions. A processor device may also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment may include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the aspects disclosed herein may be embodied directly in hardware, in a software module executed by a processor device, or in a combination of the two. A software module may reside in RAM memory, flash memory, ROM memory, EPROM memory, EEPROM memory, registers, hard disk, a removable disk, a CD-ROM, or any other form of a non-transitory computer-readable storage medium. An exemplary storage medium may be coupled to the processor device such that the processor device may read information from, and write information to, the storage medium. In the alternative, the storage medium may be integral to the processor device. The processor device and the storage medium may reside in an ASIC. The ASIC may reside in a user terminal. In the alternative, the processor device and the storage medium may reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more aspects or that one or more aspects necessarily include logic for deciding, with or without other input or prompting, whether these features, elements and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various aspects, it may be understood that various omissions, substitutions, and changes in the form and details of the devices or algorithms illustrated may be made without departing from the spirit of the disclosure. As may be recognized, certain aspects described herein may be embodied within a form that does not provide all of the features and benefits set forth herein, as some features may be used or practiced separately from others.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected,” or “operably coupled,” to each other to achieve the desired functionality, and any two components capable of being so associated may also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative aspects has been presented for purposes of illustration and of description. It is not intended to be exhaustive or limiting with respect to the precise form disclosed, and modifications and variations are possible in light of the above teachings or may be acquired from practice of the disclosed aspects. It is intended that the scope of the invention be defined by the claims appended hereto and their equivalents.

1. A method comprising:
determining, by a processor executing computer-readable instructions stored on a memory, a raw material environmental footprint profile for one or more raw materials to be used in a feed formulation for an animal product;
determining, by the processor, an animal feed environmental footprint profile, wherein the animal feed environmental footprint profile is determined based on the feed formulation comprising the one or more raw materials;
determining, by the processor, an animal production and processing environmental footprint profile for producing and processing the animal product;
determining, by the processor, an overall environmental footprint profile by combining the raw material environmental footprint profile, the animal feed environmental footprint profile, and the animal production and processing environmental footprint profile; and
adjusting, by the processor, the feed formulation based on the overall environmental footprint profile to achieve a target emission value.

2. The method of claim 1, wherein determining the raw material environmental footprint profile for a raw material of the one or more raw materials comprises:
receiving, by the processor, a plurality of inputs related to the raw material;
determining, by the processor, a value of one or more environmental indicators for each of the plurality of inputs; and
creating, by the processor, the raw material environmental footprint profile for the raw material based on the value of the one or more environmental indicators.

3. The method of claim 2, wherein the plurality of inputs comprise at least one of a supplier input, a species input, a country of origin input, or a transportation input.

4. The method of claim 1, wherein the feed formulation comprises a percentage of each of the one or more raw materials used in the feed formulation, and wherein determining the animal feed environmental footprint profile comprises computing, by the processor, a product of the percentage of each of the one or more raw materials with a value of an environmental indicator for the each of the one or more raw materials, wherein the value is determined based on the raw material environmental footprint profile.

5. The method of claim 1, wherein determining the animal production and processing environmental footprint profile further comprises:
receiving, by the processor, a plurality of inputs;
determining, by the processor, a value of one or more environmental indicators based for each of the plurality of inputs; and
creating, by the processor, the animal production and processing environmental footprint profile based on the value of the one or more environmental indicators.

6. The method of claim 5, wherein the plurality of inputs comprise at least one of a chemical input, a transportation input, an energy input, a facilities input, a life stage input, or a parasite input.

7. The method of claim 1, wherein adjusting the feed formulation comprises changing a percentage of at least one of the one or more raw materials in the feed formulation.

8. The method of claim 1, wherein adjusting the feed formulation comprising replacing at least one of the one or more raw materials in the feed formulation with another raw material.

9. A non-transitory computer-readable medium comprising computer-executable instructions stored thereon that when executed by at least one processor, cause the at least one processor to:
determine a raw material environmental footprint profile for one or more raw materials to be used in a feed formulation for an animal product;
determine an animal feed environmental footprint profile, wherein the animal feed environmental footprint profile is determined based on the feed formulation comprising the one or more raw materials;
determine an animal production and processing environmental footprint profile for producing and processing the animal product;
determine an overall environmental footprint profile by combining the raw material environmental footprint profile, the animal feed environmental footprint profile, and the animal production and processing environmental footprint profile; and
adjust the feed formulation based on the overall environmental footprint profile to achieve a target emission value.

10. The non-transitory computer-readable medium of claim 9, wherein the at least one processor further executes computer-executable instructions to:
receive, by the processor, a plurality of inputs related to the raw material;
determine, by the processor, a value of one or more environmental indicators for each of the plurality of inputs; and
create, by the processor, the raw material environmental footprint profile for the raw material based on the value of the one or more environmental indicators.

11. The non-transitory computer-readable medium of claim 9, wherein the feed formulation comprises a percentage of each of the one or more raw materials used in the feed formulation, and wherein to determine the animal feed environmental footprint profile, the at least one processor further executes computer-executable instructions to compute a product of the percentage of each of the one or more raw materials with a value of an environmental indicator for the each of the one or more raw materials, wherein the value is determined based on the raw material environmental footprint profile.

12. The non-transitory computer-readable medium of claim 9, wherein the at least one processor further executes computer-executable instructions to:
receive, by the processor, a plurality of inputs;
determine, by the processor, a value of one or more environmental indicators based for each of the plurality of inputs; and
create, by the processor, the animal production and processing environmental footprint profile based on the value of the one or more environmental indicators.

13. The non-transitory computer-readable medium of claim 9, wherein adjusting the feed formulation comprises changing a percentage of at least one of the one or more raw materials in the feed formulation or replacing at least one of the one or more raw materials in the feed formulation with another raw material.

14. A system comprising:
a memory having computer-executable instructions stored thereon; and
a processor that executes the computer-executable instructions to:
determine a raw material environmental footprint profile for one or more raw materials to be used in a feed formulation for an animal product;
determine an animal feed environmental footprint profile, wherein the animal feed environmental footprint profile is determined based on the feed formulation comprising the one or more raw materials;
determine an animal production and processing environmental footprint profile for producing and processing the animal product;
determine an overall environmental footprint profile by combining the raw material environmental footprint profile, the animal feed environmental footprint profile, and the animal production and processing environmental footprint profile; and
adjust the feed formulation based on the overall environmental footprint profile to achieve a target emission value.

15. The system of claim 14, wherein the processor further executes computer-executable instructions to:
receive, by the processor, a plurality of inputs related to the raw material;
determine, by the processor, a value of one or more environmental indicators for each of the plurality of inputs; and
create, by the processor, the raw material environmental footprint profile for the raw material based on the value of the one or more environmental indicators.

16. The system of claim 15, wherein the plurality of inputs comprise at least one of a supplier input, a species input, a country of origin input, or a transportation input.

17. The system of claim 14, wherein the feed formulation comprises a percentage of each of the one or more raw materials used in the feed formulation, and wherein to determine the animal feed environmental footprint profile, the processor further executes computer-executable instructions to compute a product of the percentage of each of the one or more raw materials with a value of an environmental indicator for the each of the one or more raw materials, wherein the value is determined based on the raw material environmental footprint profile.

18. The system of claim 14, wherein the processor further executes computer-executable instructions to:
receive, by the processor, a plurality of inputs;
determine, by the processor, a value of one or more environmental indicators based for each of the plurality of inputs; and
create, by the processor, the animal production and processing environmental footprint profile based on the value of the one or more environmental indicators.

19. The system of claim 14, wherein adjusting the feed formulation comprises changing a percentage of at least one of the one or more raw materials in the feed formulation.

20. The system of claim 14, wherein adjusting the feed formulation comprising replacing at least one of the one or more raw materials in the feed formulation with another raw material.
